(19) United States
(12) Patent Application Publication
(10) Pub. No.: US 2007/0254378 A1
(43) Pub. Date: Nov. 1, 2007

(54) CHELATING MONOMERS AND POLYMERS

(75) Inventors: Hongmin Zhang, Fremont, CA (US); Egisto Boschetti, Croissy-sur-Seine (FR); Lee O. Lomas, Pleasanton, CA (US); Pil-Je Um, Edmonds, WA (US)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: Bio-Rad Laboratories, Inc., Hercules, CA (US)

(21) Appl. No.: 11/682,655

(22) Filed: Mar. 6, 2007

Related U.S. Application Data
(60) Provisional application No. 60/779,790, filed on Mar. 6, 2006.

(51) Int. Cl. G01N 24/00; B01D 3/00; B01D 59/44; C08F 30/04

(52) U.S. Cl. 436/173; 210/633; 250/281; 526/240

(57) ABSTRACT

This invention provides chelating moieties that comprise an aryl group. Monomers that include the chelating moieties can be polymerized into chelating polymers. Chelating polymers are useful to chelate metals. Chelating polymers in the form of metal chelates are useful for binding analytes, such as polypeptides that comprise histidine residues. Chelating polymers can be includes in articles such as chips and chromatographic materials.

### CROSS-REFERENCES TO RELATED APPLICATIONS

The present application claims the benefit of U.S. Provisional Patent Application No. 60/779,790, filed Mar. 6, 2006, which is incorporated herein by reference in its entirety for all purposes.

### BACKGROUND OF THE INVENTION

Metal chelating materials have many uses in industry and research. Metal chelators are used to remove metals from solution, such as water, in purification procedures. Metal chelates, that is, chelators with metal ions attached, also have found use in biochemistry to bind biomolecules such as proteins. For example, metal chelates are used to bind proteins comprising histidine residues.

Examples of metal chelators include ethylenediaminetetraacetic acid, iminodiacetic acid and nitrilotriacetic acid. The latter are described, for example, in U.S. Pat. Nos. 4,877,830 and 5,284,933 (Dobeli et al.).

U.S. Pat. Nos. 5,719,060 and 6,225,047, both to Hutchens and Yip, and 6,897,027 (Rich et al.) describe the use of mass spectrometry probes derivatized with metal chelates for capturing proteins and detecting them using surface-enhanced laser desorption/ionization mass spectrometry. See also, Tishchenko, et al., “Purification of the specific immunoglobulin G1 by immobilized metal ion affinity chromatography using nickel complexes of chelating porous and nonporous polymeric sorbents based on poly(methacrylic esters)-Effect of polymer structures”, Journal of Chromatography A, 2002, 954, 115-126 and Horak, et al., “A novel highly copper (II)-selective chelating ion exchanger based on poly(glycidyl methacrylate-co-ethylene dimethacrylate) beads modified with aspartic acid derivative”, Journal of Applied Polymer Science, 2001, 80, 913-916.

Immobilized Metal Ion Affinity Chromatography (IMAC) is one of the most frequently used techniques for purification of fusion proteins containing affinity sites for metal ions (Porath et al., Nature 258:598-599, 1975). Porath et al. disclose derivatization of a resin with iminodiacetic acid (IDA) and chelating metal ions to the IDA-derivatized resin. The proteins are immobilized by binding to the metal ion(s) through amino acid residues capable of donating electrons. Smith et al. disclose in U.S. Pat. No. 4,569,794 that certain amino acids residues of proteins can bind to the immobilized metal ions, for example, histidine. Smith et al. demonstrate that a fusion protein comprising a desired polypeptide with an attached metal chelating peptide may be purified from contaminants by passing the fusion protein and contaminants through columns containing immobilized metal ions. The metal chelating peptide component of the fusion protein will chelate the immobilized metal ions, while the majority of the contaminants freely pass through the column. By changing the conditions of the column, the fusion protein can be released and then can be collected in relatively pure form.

Even though much has been achieved in metal affinity chromatography, there is still a need for improved compositions and methods for metal affinity immobilization of proteins and other analytes of interest. The present invention provides such improved compositions.

### BRIEF SUMMARY OF THE INVENTION

The utility and versatility of analyses using polymeric surfaces that interact with an analyte can be enhanced by the use of polymers of different formats that bind to a selected analyte under different conditions. For example, when the polymer has metal chelating properties, it is generally desired to select conditions for an analysis under which the interaction between the metal chelate groups on the polymer and a selected analyte are optimized and non-specific interactions between the polymer and contaminants, or species irrelevant to the analysis, are minimized. In general, this result can be obtained by optimizing the metal chelating properties of the analyte, thereby maximizing the interaction between the analyte and the metal chelating polymer.

Many systems have been developed in recent years for the rapid purification of recombinant proteins. An efficient method relies on specific interactions between an affinity tag (usually a short peptide with specific molecular recognition properties, e.g., maltose binding protein, thioredoxin, cellulose binding domain, glutathione S-transferase, and polyhistidines, and an immobilized ligand. Immobilized metal-affinity chromatography (IMAC) is widely used.

IMAC is based on selective interaction between a solid matrix immobilized with either Cu²⁺ or Ni²⁺ and a polyhistidine tag (His tag). Proteins containing a polyhistidine tag are selectively bound to the matrix while other proteins are removed by washing. See, For example, Stiborova et al., Biotech Bioengineer. 82: 605-611 (2003).

Accordingly, in a first embodiment, the invention provides a reactive, preferably a polymerizable monomer that includes a chelating or a masked (i.e., protected) chelating moiety. Also provided are articles (e.g., polymers, chromatographic supports, biochips, and the like) that incorporate the monomers of the invention, and methods that utilize the monomers and articles formed from the monomers of the invention.

In a first aspect, the invention provides a compound having the formula:
A-L-Ar-L¹-CM (I)
in which, the symbol L represents a linker selected from zero-order linkers, and higher order linkers. Exemplary linkers have a formula selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO. In these formulae, the symbol L³ represents a substituted or unsubstituted alkyl or a substituted or unsubstituted heteroalkyl moiety. The index u is 0 or 1. Groups corresponding to Ar include substituted or unsubstituted aryl and substituted or unsubstituted heteroaryl moieties. In a preferred embodiment, Ar is substituted or unsubstituted phenyl. L¹ is a linker. Exemplary linkers according to L¹ are (CR¹R²)ₘ, O(CR¹R²)ₘ, (CR¹R²)ₘO S(CR¹R²)ₘ, (CR¹R²)ₘS and (R³)N(CR¹R²)ₘ. The symbols R¹, R² and R³ represent groups that are independently selected from H and substituted or unsubstituted alkyl. The index m is an integer from 0 to 10.

The symbol A represents the point of attachment of the remainder of the illustrated structure to another species. Exemplary species to which the remainder of the illustrated structure is joined include a linker or portion of a linker, a solid support, a linker to a solid support, a monomeric subunit of a polymer, a linker to a monomeric subunit of a polymer, a backbone of a polymer and a linker to a backbone of a polymer.

The symbol CM represents a chelating moiety having the formula: 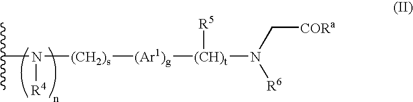
wherein the indeces n, s and t are integers independently selected from 0 and 1. In a preferred embodiment, at least one of s and t is 1. A¹ represent s a substituted or unsubstituted aryl or substituted or unsubstituted heteroaryl moiety. R^{a} is selected from OR^{b} and O⁻M⁺. M⁺ is a metal ion. R^{b} is H, substituted or unsubstituted alkyl or substituted or unsubstituted heteroalkyl. Groups corresponding to R⁴, R⁵ and R⁶ are independently selected from H and (CH₂)_{q}COR^{c}; preferably, at least one of R⁴, R⁵ and R⁶ is other than H. The index q is an integer from 0 to 10, preferably 0 to 5, more preferably 0 to 3. The index g is an integer from 0 to 3, preferably 0, 1 or 2. The symbol R^{c} represents OR^{d} or O⁻M⁺. M⁺ is a metal ion, preferably a chelated metal ion. R^{d} is H, substituted or unsubstituted alkyl or substituted or unsubstituted heteroalkyl.

The wavy vertical line at the left terminus of Formula II represents the attachment point of the chelating moiety (CM) to L¹.

Exemplary chelating moieties include those moieties including iminodiacetic acid, ethylene diamine triacetic acid, nitrilo-triacetic acid, terpyridine, aspartic acid, hydroxyaspartic acid, 5-[(2-aminoethyl)amino]methyl quinoline-8-ol, N-(2-pyridylmethyl)glycine, sporopollenin, N-carboxymethylated tetraaza macrocycles, which are attached to the polymeric backbone through -L-Ar-L¹-.

In Formula I, L is a radical. It can represent a terminal moiety of a chelating moiety of a chelating monomer, for example a monomer comprising a group for polymerization. Alternatively, it may represent a linker that attached the moiety to another chelating moiety in a polymer or to another molecular structure, such as a solid support. In the homopolymers of the invention, two or more of the chelating subunits are joined through linker, L. Alternatively, in the co-polymers of the invention, the linker can attach a chelating subunit to another chelating subunit or to a non-chelating subunit. Exemplary linkers include zero-order linkers, substituted or unsubstituted alkyl and substituted or unsubstituted heteroalkyl moietes.

In a second aspect, the invention provides a device including a solid support. The solid support has a polymer chemisorbed or physisorbed thereto. The polymer includes linked monomeric subunits, e.g., a plurality of monomeric chelating subunits having the formula: 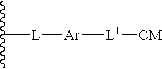
in which the identity of the various radicals is the same as discussed above.

In another aspect, the invention provides a device including a solid support functionalized with a plurality of chelating subunits having the formula set forth above.

In a fourth aspect, there is provided a method of detecting an analyte. The method includes: (a) binding the analyte to a metal ion chelated by a polymer of the invention bound to a substrate; and (b) detecting the bound analyte. The polymer includes linked monomeric subunits, e.g., a plurality of linked monomeric chelating subunits having the formula set forth above.

In a further aspect, the invention provides a method of separating an analyte from a contaminant. The method includes: (a) binding the analyte to a metal ion chelated by a chelating subunit of a polymer of the invention; and (b) removing the contaminant from the bound analyte. The polymer includes linked monomeric subunits, e.g., chelating subunits having the formula set forth above.

In a still further aspect, the invention provides a mass spectrometer. The mass spectrometer includes an ion source. The ion source includes a probe interface that positions a probe in an interrogatable relationship with a laser source, and a probe engaged with the interface. The probe includes a substrate having a surface. The surface includes a polymer chemisorbed or physisorbed thereto. The polymer includes linked monomeric, e.g., a plurality of chelating monomeric subunits having the formula set forth above.

In another aspect, the invention provides a method of removing a metal ion from a solution. The method includes: (a) binding said metal ion with a chelating subunit of a polymer forming a polymer-metal ion complex; and (b) separating the polymer-metal ion complex from the solution, thereby removing said metal ion from said solution. The polymer includes linked monomeric, e.g., a plurality of chelating monomeric subunits having the formula set forth above.

In another aspect, there is provided a method of making a chelating polymer of the invention. The method includes (a) polymerizing a monomer having the formula:
PM-L-Ar-L¹-CM
P wherein PM is a polymerizable moiety that includes at least one bond which is a member selected from H₂C═CH and H₂C═C(CH₃).

Other aspects, objects and advantages of the instant invention will be apparent from the detailed description that follows.

### BRIEF DESCRIPTION OF THE DRAWINGS

FIG. 1 shows chemical formulae for several chelating monomers of this invention. Exemplary chelating monomers include N-(p-vinylphenyl)methyl-ethylenediamininetriacetic acid, O-methacryloyl-N,N-bis-carboxymethyl tyrosine, N-{[4-(methacryloylamino)phenyl]-amino}ethyl-N,N′N″-ethylenediaminetriactic acid and N-{[4-(2-hydroxy-3-methacryloyloxypropylamino)phenyl]-amino}ethyl-N,N′N″-ethylenediaminetriactic acid

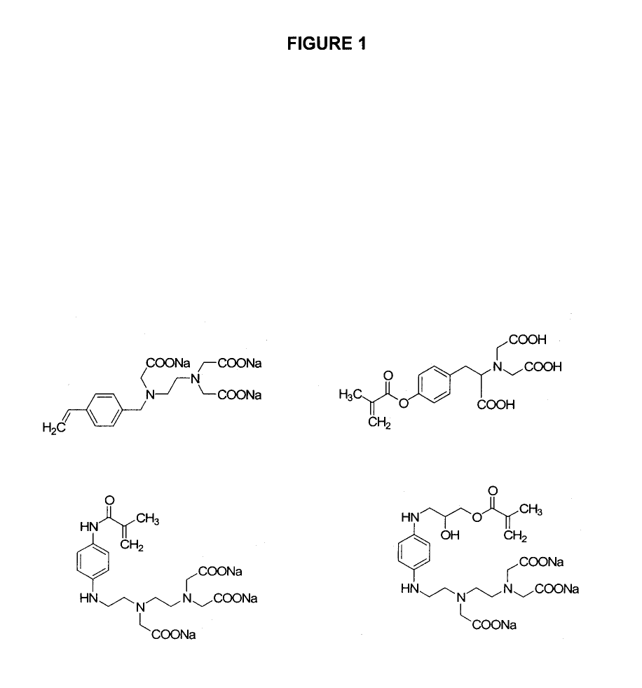

FIG. 2 shows an exemplary format for the polymer of Example 7.

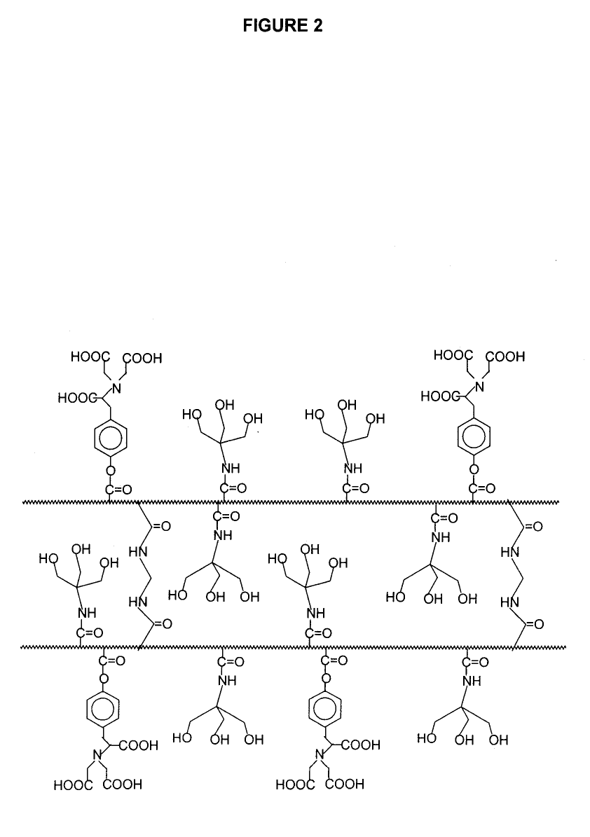

FIG. 3 is a diagram of a portion of an exemplary surface on which a linker arm, capable of binding to a polymer of the invention, is attached.

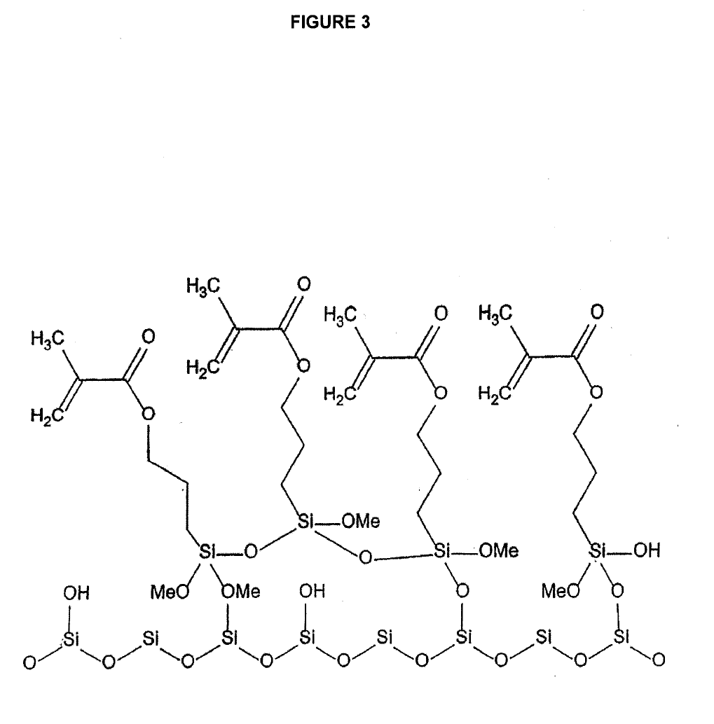

FIG. 4 shows mass spectra of a peptide, ITIH4 internal fragment, captured on a SELDI mass spectrometry probe comprising the polymer of Example 7 and detected by laser desorption mass spectrometry. The spectra correspond to the samples of Example 9.

FIG. 5 shows an exemplary biochip substrate of use with the materials of the invention.

### DETAILED DESCRIPTION OF THE INVENTION

### I. Abbreviations

EAM (energy absorbing moiety); SPA (sinapinic acid); CHCA (alpha-cyano-4-hydroxy-succininc acid); CHCAMA, α-cyano-4-methacryloyloxy-cinnamic acid; DHBMA, 2,5-dimethacryloyloxy benzoic acid; DHAPheMA, 2,6-dimethacryloyloxyacetophenone.

### II. Definitions

Unless defined otherwise, all technical and scientific terms used herein generally have the same meaning as commonly understood by one of ordinary skill in the art to which this invention belongs. Generally, the nomenclature used herein and the laboratory procedures in cell culture, molecular genetics, organic chemistry, and nucleic acid chemistry and hybridization described below are those well known and commonly employed in the art. Standard techniques are used for nucleic acid and peptide synthesis. The techniques and procedures are generally performed according to conventional methods in the art and various general references, which are provided throughout this document. The nomenclature used herein and the laboratory procedures in analytical chemistry, and organic synthetic described below are those well known and commonly employed in the art. Standard techniques, or modifications thereof, are used for chemical syntheses and chemical analyses.

Where substituent groups are specified by their conventional chemical formulae, written from left to right, they equally encompass the chemically identical substituents which would result from writing the structure from right to left, e.g., —CH₂O— is intended to also recite —OCH₂—; —NHS(O)₂— is also intended to represent. —S(O)₂HN—, etc.

The term “alkyl,” by itself or as part of another substituent, means, unless otherwise stated, a straight or branched chain, or cyclic hydrocarbon radical, or combination thereof, which may be fully saturated, mono- or polyunsaturated and can include di- and multivalent radicals, having the number of carbon atoms designated (i.e. C₁-C₁₀ means one to ten carbons). Examples of saturated hydrocarbon radicals include, but are not limited to, groups such as methyl, ethyl, n-propyl, isopropyl, n-butyl, t-butyl, isobutyl, sec-butyl, cyclohexyl, (cyclohexyl)methyl, cyclopropylmethyl, homologs and isomers of, for example, n-pentyl, n-hexyl, n-heptyl, n-octyl, and the like. An unsaturated alkyl group is one having one or more double bonds or triple bonds. Examples of unsaturated alkyl groups include, but are not limited to, vinyl, 2-propenyl, crotyl, 2-isopentenyl, 2-(butadienyl), 2,4-pentadienyl, 3-(1,4-pentadienyl), ethynyl, 1- and 3-propynyl, 3-butynyl, and the higher homologs and isomers. The term “alkyl,” unless otherwise noted, is also meant to include those derivatives of alkyl defined in more detail below, such as “heteroalkyl.” Alkyl groups, which are limited to hydrocarbon groups are termed “homoalkyl”.

The term “heteroalkyl,” by itself or in combination with another term, means, unless otherwise stated, a stable straight or branched chain, or cyclic hydrocarbon radical, or combinations thereof, consisting of the stated number of carbon atoms and at least one heteroatom selected from the group consisting of O, N, Si and S, and wherein the nitrogen and sulfur atoms may optionally be oxidized and the nitrogen heteroatom may optionally be quaternized. The heteroatom(s) O, N and S and Si may be placed at any interior position of the heteroalkyl group or at the position at which the alkyl group is attached to the remainder of the molecule. Examples include, but are not limited to, —CH₂—CH₂—O—CH₃, —CH₂—CH₂—NH—CH₃, —CH₂—CH₂—N(CH₃)—CH₃, —CH₂—S—CH₂—CH₃, —CH₂—CH₂, —S(O)—CH₃, —CH₂—CH₂—S(O)₂—CH₃, —CH═CH—O—CH₃, —Si(CH₃)₃, —CH₂—CH═N—OCH₃, and —CH═CH—N(CH₃)—CH₃. Up to two heteroatoms may be consecutive, such as, for example, —CH₂—NH—OCH₃ and —CH₂—O—Si(CH₃)₃. Similarly, the term “heteroalkylene” by itself or as part of another substituent means a divalent radical derived from heteroalkyl, as exemplified, but not limited by, —CH₂—CH₂—S—CH₂—CH₂— and —CH₂—S—CH₂—CH₂—NH—CH₂—. For heteroalkylene groups, heteroatoms can also occupy either or both of the chain termini (e.g., alkyleneoxy, alkylenedioxy, alkyleneamino, alkylenediamino, and the like). Still further, for alkylene and heteroalkylene linking groups, no orientation of the linking group is implied by the direction in which the formula of the linking group is written. For example, the formula —C(O)₂R′— represents both —C(O)₂R′— and —R′C(O)₂—.

Substituents for the alkyl and heteroalkyl radicals (including those groups often referred to as alkylene, alkenyl, heteroalkylene, heteroalkenyl, alkynyl, cycloalkyl, heterocycloalkyl, cycloalkenyl, and heterocycloalkenyl) can be one or more of a variety of groups selected from, but not limited to: —OR′, ═O, ═NR′, ═N—OR′, —NR′R″, —SR′, -halogen, —SiR′R″R′″, —OC(O)R′, —C(O)R′, —CO₂R′, —CONR′R″, —OC(O)NR′R″, —NR″C(O)R′, —NR′—C(O)NR″R′″, —NR″C(O)₂R′, —NR—C(NR′R″R′″)═NR″″, —NR—C(NR′R″)═NR′″, —S(O)R′, —S(O)₂R′, —S(O)₂NR′R″, —NRSO₂R′, —CN and —NO₂ in a number ranging from zero to (2m′+1), where m′ is the total number of carbon atoms in such radical. R′, R″, R′″ and R″″ each preferably independently refer to hydrogen, substituted or unsubstituted heteroalkyl, substituted or unsubstituted aryl, e.g., aryl substituted with 1-3 halogens, substituted or unsubstituted alkyl, alkoxy or thioalkoxy groups, or arylalkyl groups. When a compound of the invention includes more than one R group, for example, each of the R groups is independently selected as are each R′, R″, R′″ and R″″ groups when more than one of these groups is present. When R′ and R″ are attached to the same nitrogen atom, they can be combined with the nitrogen atom to form a 5-, 6-, or 7-membered ring. For example, —NR′R″ is meant to include, but not be limited to, 1-pyrrolidinyl and 4-morpholinyl. From the above discussion of substituents, one of skill in the art will understand that the term “alkyl” is meant to include groups including carbon atoms bound to groups other than hydrogen groups, such as haloalkyl (e.g., —CF₃ and —CH₂CF₃) and acyl (e.g., —C(O)CH₃, —C(O)CF₃, —C(O)CH₂OCH₃, and the like).

Each of the above terms is meant to include both substituted and unsubstituted forms of the indicated radical.

As used herein, the term “heteroatom” is meant to include oxygen (O), nitrogen (N), sulfur (S) and silicon (Si).

As used herein, the terms “polymer” and “polymers” include “copolymer” and “copolymers,” and are used interchangeably with the terms “oligomer” and “oligomers.”

“Attached,” as used herein encompasses interactions including chemisorption and physisorption.

“Independently selected” is used herein to indicate that the groups so described can be identical or different.

“Biomolecule” or “bioorganic molecule” refers to an organic molecule typically made by living organisms. This includes, for example, molecules comprising nucleotides, amino acids, sugars, fatty acids, steroids, nucleic acids, polypeptides, peptides, peptide fragments, carbohydrates, lipids, and combinations of these (e.g., glycoproteins, ribonucleoproteins, lipoproteins, or the like). Biomolecules can be sourced from any biological material.

“Gas phase ion spectrometer” refers to an apparatus that detects gas phase ions. Gas phase ion spectrometers include an ion source that supplies gas phase ions. Gas phase ion spectrometers include, for example, mass spectrometers, ion mobility spectrometers, and total ion current measuring devices. “Gas phase ion spectrometry” refers to the use of a gas phase ion spectrometer to detect gas phase ions.

“Mass spectrometer” refers to a gas phase ion spectrometer that measures a parameter that can be translated into mass-to-charge ratios of gas phase ions. Mass spectrometers generally include an ion source and a mass analyzer. Examples of mass spectrometers are time-of-flight, magnetic sector, quadrupole filter, ion trap, ion cyclotron resonance, electrostatic sector analyzer and hybrids of these. “Mass spectrometry” refers to the use of a mass spectrometer to detect gas phase ions.

“Laser desorption mass spectrometer” refers to a mass spectrometer that uses laser energy as a means to desorb, volatilize, and ionize an analyte.

“Mass analyzer” refers to a sub-assembly of a mass spectrometer that comprises means for measuring a parameter that can be translated into mass-to-charge ratios of gas phase ions. In a time-of-flight mass spectrometer the mass analyzer comprises an ion optic assembly that accelerates ions into the flight tube, a flight tube and an ion detector.

“Ion source” refers to a sub-assembly of a gas phase ion spectrometer that provides gas phase ions. In one embodiment, the ion source provides ions through a desorption/ionization process. Such embodiments generally comprise a probe interface that positionally engages a probe in an interrogatable relationship to a source of ionizing energy (e.g., a laser desorption/ionization source) and in concurrent communication at atmospheric or subatmospheric pressure with a detector of a gas phase ion spectrometer.

Forms of ionizing energy for desorbing/ionizing an analyte from a solid phase include, for example: (1) laser energy; (2) fast atoms (used in fast atom bombardment); (3) high energy particles generated via beta decay of radionucleides (used in plasma desorption); and (4) primary ions generating secondary ions (used in secondary ion mass spectrometry). The preferred form of ionizing energy for solid phase analytes is a laser (used in laser desorption/ionization), in particular, nitrogen lasers, Nd-Yag lasers and other pulsed laser sources. “Fluence” refers to the energy delivered per unit area of interrogated image. A high fluence source, such as a laser, will deliver about 1 mJ/mm² to about 50 mJ/mm². Typically, a sample is placed on the surface of a probe, the probe is engaged with the probe interface and the probe surface is exposed to the ionizing energy. The energy desorbs analyte molecules from the surface into the gas phase and ionizes them.

Other forms of ionizing energy for analytes include, for example: (1) electrons that ionize gas phase neutrals; (2) strong electric field to induce ionization from gas phase, solid phase, or liquid phase neutrals; and (3) a source that applies a combination of ionization particles or electric fields with neutral chemicals to induce chemical ionization of solid phase, gas phase, and liquid phase neutrals.

“Surface-enhanced laser desorption/ionization” or “SELDI” refers to a method of desorption/ionization gas phase ion spectrometry (e.g., mass spectrometry) in which the analyte is captured on the surface of a SELDI probe that engages the probe interface of the gas phase ion spectrometer. In “SELDI MS,” the gas phase ion spectrometer is a mass spectrometer. SELDI technology is described in, e.g., U.S. Pat. No. 5,719,060 (Hutchens and Yip) and U.S. Pat. No. 6,225,047 (Hutchens and Yip).

“Surface-Enhanced Affinity Capture” (“SEAC”) or “affinity gas phase ion spectrometry” (e.g., “affinity mass spectrometry”) is a version of the SELDI method that uses a probe comprising an absorbent surface (a “SEAC probe”). “Adsorbent surface” refers to a sample presenting surface of a probe to which an adsorbent (also called a “capture reagent” or an “affinity reagent”) is attached. An adsorbent is any material capable of binding an analyte (e.g., a target polypeptide or nucleic acid). “Chromatographic adsorbent” refers to a material typically used in chromatography. “Biospecific adsorbent” refers an adsorbent comprising a biomolecule, e.g., a nucleic acid molecule (e.g., an aptamer), a polypeptide, a polysaccharide, a lipid, a steroid or a conjugate of these (e.g., a glycoprotein, a lipoprotein, a glycolipid, a nucleic acid (e.g., DNA)-protein conjugate). Further examples of adsorbents for use in SELDI can be found in U.S. Pat. No. 6,225,047 (Hutchens and Yip, “Use of retentate chromatography to generate difference maps,” May 1, 2001).

In some embodiments, a SEAC probe is provided as a pre-activated surface that can be modified to provide an adsorbent of choice. For example, certain probes are provided with a reactive moiety that is capable of binding a biological molecule through a covalent bond. Epoxide and acyl-imidizole are useful reactive moieties to covalently bind biospecific adsorbents such as antibodies or cellular receptors.

In a preferred embodiment affinity mass spectrometry involves applying a liquid sample comprising an analyte to the adsorbent surface of a SELDI probe. Analytes such as polypeptides, having affinity for the adsorbent, bind to the probe surface. Typically, the surface is then washed to remove unbound molecules, and leaving retained molecules. The extent of analyte retention is a function of the stringency of the wash used. An energy absorbing material (e.g., matrix) is then applied to the adsorbent surface. Retained molecules are then detected by laser desorption/ionization mass spectrometry.

SELDI is useful for protein profiling, in which proteins in a sample are detected using one or several different SELDI surfaces. In turn, protein profiling is useful for difference mapping, in which the protein profiles of different samples are compared to detect differences in protein expression between the samples.

“Surface-Enhanced Neat Desorption” or “SEND” is a version of SELDI that involves the use of probes (“SEND probe”) comprising a layer of energy absorbing molecules attached to the probe surface. Attachment can be, for example, by covalent or non-covalent chemical bonds. Unlike traditional MALDI, the analyte in SEND is not required to be trapped within a crystalline matrix of energy absorbing molecules for desorption/ionization.

SEAC/SEND is a version of SELDI in which both a capture reagent and an energy-absorbing molecule are attached to the sample-presenting surface. SEAC/SEND probes therefore allow the capture of analytes through affinity capture and desorption without the need to apply external matrix. The C18 SEND chip is a version of SEAC/SEND, comprising a C18 moiety which functions as a capture reagent, and a CHCA moiety that functions as an energy-absorbing moiety.

“Surface-Enhanced Photolabile Attachment and Release” or “SEPAR” is a version of SELDI that involves the use of probes having moieties attached to the surface that can covalently bind an analyte, and then release the analyte through breaking a photolabile bond in the moiety after exposure to light, e.g., laser light. SEPAR is further described in U.S. Pat. No. 5,719,060.

“Analyte” refers to any component of a sample that to be detected and/or separated from a contaminant. The term can refer to a single component or a plurality of components in the sample. Analytes include, for example, biomolecules.

“Eluant” or “wash solution” refers to an agent, typically a solution, which is used to affect or modify adsorption of an analyte to an adsorbent surface and/or remove unbound materials from the surface. The elution characteristics of an eluant can depend, for example, on pH, ionic strength, hydrophobicity, degree of chaotropism, detergent strength and temperature.

As used herein, contaminant, refers to species removed from a sample or assay mixture. The contaminant can be an extraneous species not of interest in the assay, or it can be material of interest that is present in excess of the amount needed to perform the assay. When the excess “contaminating” analyte negatively affects the dynamic range of detection in the assay, its removal provides a method of enhancing properties of the assay including, but not limited to, its sensitivity.

The terms, “assay mixture” and “sample,” are used interchangeable to refer to a mixture that includes the analyte and other components. The other components are, for example, diluents, buffers, detergents, and contaminating species, debris and the like that are found mixed with the target. Illustrative examples include urine, sera, blood plasma, total blood, saliva, tear fluid, cerebrospinal fluid, secretory fluids from nipples and the like. Also included are solid, gel or sol substances such as mucus, body tissues, cells and the like suspended or dissolved in liquid materials such as buffers, extractants, solvents and the like.

### III. The Embodiments

A. Introduction

The present invention provides chelating moieties that can be used to capture, purify and detect analytes. In certain embodiments, the chelating moieties can be incorporated into polymers, including hydrogels. These polymers can be formed by polymerizing monomers that incorporate a chelating moiety. Alternatively, one can derivatize an existing polymer with chelating moieties. These polymers can be incorporated into articles in which the polymers are attached to solid supports. Alternatively, the chelating moieties can be attached to solid supports without prior incorporation into polymers. The articles, in turn, can be used for a variety of utilities. These include, for example, chelating metals from solutions (e.g., in water purification) and capturing biomolecules, such as proteins, from a sample after the chelating moieties are charged with metal ions. For example, it is well known that nickel chelates preferentially bind proteins comprising histidine residues, for example His-tagged proteins. After elimination of non-bound polypeptides, bound polypeptides are in more purified form. These polypeptides can be collected in more purified from by desorbing from the metal chelate (e.g. by elution) or they can be detected by, for example, laser desorption/ionization mass spectrometry.

B. Chelating Moieties

The chelating moieties of this invention have the formula:
A-L-Ar-L¹-CM (I)
in which, the symbol L represents a linker selected from zero-order linkers, and higher order linkers. Exemplary linkers have a formula selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO. In these formulae, the symbol L³ represents a substituted or unsubstituted alkyl or a substituted or unsubstituted heteroalkyl moiety. The index u is 0 or 1. Groups corresponding to Ar include substituted or unsubstituted aryl and substituted or unsubstituted heteroaryl moieties. In a preferred embodiment, Ar is substituted or unsubstituted phenyl. L¹ is a linker. Exemplary linkers according to L¹ are (CR¹R²)ₘ, O(CR¹R²)ₘ, (CR¹R²)ₘO S(CR¹R²)ₘ, (CR¹R²)ₘS and (R³)N(CR¹R²)ₘ. The symbols R¹, R² and R³ represent groups that are independently selected from H and substituted or unsubstituted alkyl. The index m is an integer from 0 to 10.

The symbol A represents the point of attachment of the remainder of the illustrated structure to another species. Exemplary species to which the remainder of the illustrated structure is joined include a linker or portion of a linker, a solid support, a linker to a solid support, a monomeric subunit of a polymer, a linker to a monomeric subunit of a polymer, a backbone of a polymer and a linker to a backbone of a polymer.

The symbol CM represents a chelating moiety having the formula: 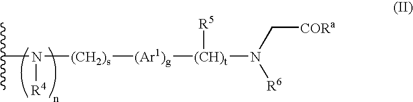
wherein the indeces n, s and t are integers independently selected from 0 and 1. In a preferred embodiment, at least one of s and t is 1. Ar¹ represents a substituted or unsubstituted aryl or substituted or unsubstituted heteroaryl moiety. R^{a} is selected from OR^{b} and O⁻M⁺. M⁺ is a metal ion. R^{b} is H, substituted or unsubstituted alkyl or substituted or unsubstituted heteroalkyl. Groups corresponding to R⁴, R⁵ and R⁶ are independently selected from H and (CH₂)_{q}COR^{c}; preferably, at least one of R⁴, R⁵ and R⁶ is other than H. The index q is an integer from 0 to 10, preferably 0 to 5, more preferably 0 to 3. The index g is an integer from 0 to 3, preferably 0, 1 or 2. The symbol R^{c} represents OR^{d} or O⁻M⁺. M⁺ is a metal ion, preferably a chelated metal ion. R^{d} is H, substituted or unsubstituted alkyl or substituted or unsubstituted heteroalkyl.

The wavy vertical line at the left terminus of Formula II represents the attachment point of the chelating moiety (CM) to L¹.

Exemplary chelating moieties include those moieties including iminodiacetic acid, ethylene diamine triacetic acid, nitrilo-triacetic acid, terpyridine, aspartic acid, hydroxyaspartic acid, 5-[(2-aminoethyl)amino]methyl quinoline-8-ol, N-(2-pyridylmethyl)glycine, sporopollenin, N-carboxymethylated tetraaza macrocycles, which are attached to the polymeric backbone through -L-Ar-L¹-.

In Formula I, L is a radical. It can represent a terminal moiety of a chelating moiety of a chelating monomer, for example a monomer comprising a group for polymerization. Alternatively, it may represent a linker that attached the moiety to another chelating moiety in a polymer or to another molecular structure, such as a solid support. In the homopolymers of the invention, two or more of the chelating subunits are joined through linker, L. Alternatively, in the co-polymers of the invention, the linker can attach a chelating subunit to another chelating subunit or to a non-chelating subunit. Exemplary linkers include zero-order linkers, substituted or unsubstituted alkyl and substituted or unsubstituted heteroalkyl moieites.

Chelating moieties can be organized into polymers and into various articles.

C. Chelating Monomers

In certain embodiments chelating polymers are formed by polymerizing monomers that comprise a polymerizable moiety and a chelating moiety of this invention.

The monomers of use in preparing the polymers of the invention, are prepared by art-recognized methods. An exemplary method is set forth in Scheme 1.

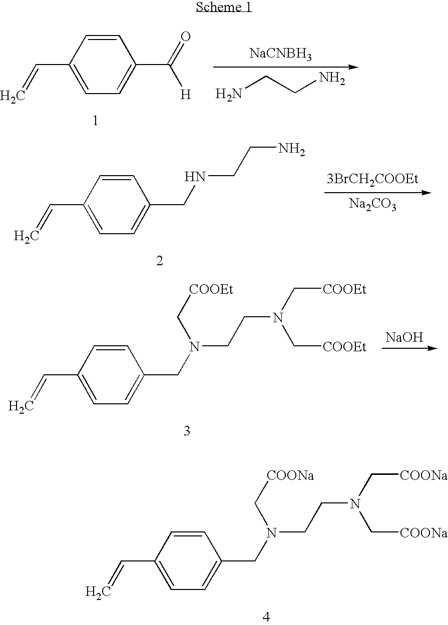

The preparation of 4 begins with reductive amination of aldehyde 1, forming amine 2. The amine is exhaustively alkylated to form ester protected chelating agent 3. Cleavage of the esters provides chelating monomer 4.

The present invention also provides a class of chelating monomers based on tyrosine. In Scheme 2 tyrosine methyl ester 5 is alkylated, providing ester protected chelating monomer 6. The esters are cleaved, providing chelant 7, which is subsequently acylated at the phenolic oxygen to place the polymerizable moiety, affording 8.

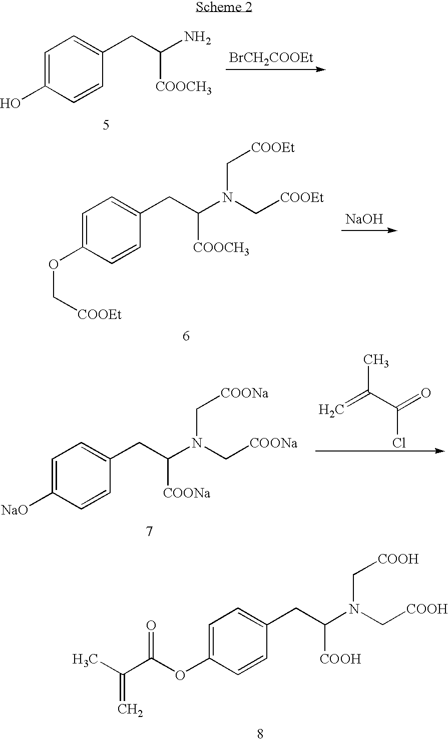

Scheme 3 sets forth an exemplary synthesis of a chelating monomer based on N-{[4-(methacryloylamino)phenyl]-aminoethyl-N,N′N′-ethylenediaminetriacetic acid, 12. N-2-hydroxyethylenediaminetriacetic acid 9 is oxidized to aldehyde 10, which is reductively aminated, forming amine 11. The amine is acylated to place the polymerizable moiety, forming 12.

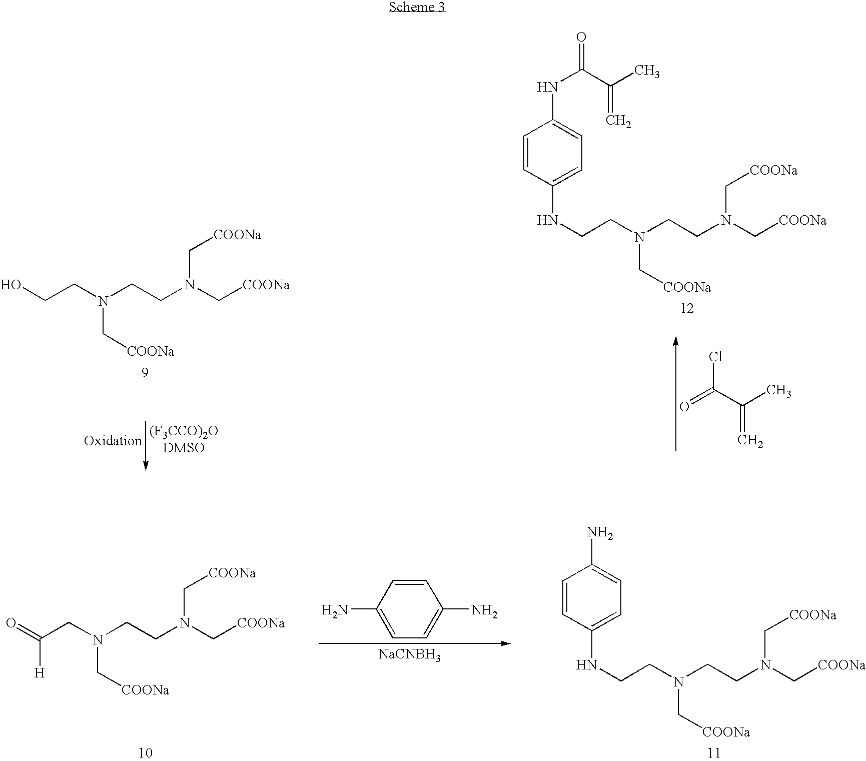

In Scheme 4, the preparation of N-{[4-(2-hydroxy-3-methacryloyloxypropylamino)phenyl]-aminoethyl-N,N′N′-ethylenediaminetriacetic acid is exemplified. N-2-hydroxyethylenediaminetriacetic acid 9 is oxidized to aldehyde 10. The aldehyde is reductively aminated, providing amine 11, which is acylated to place the polymerizable moiety, forming 13.

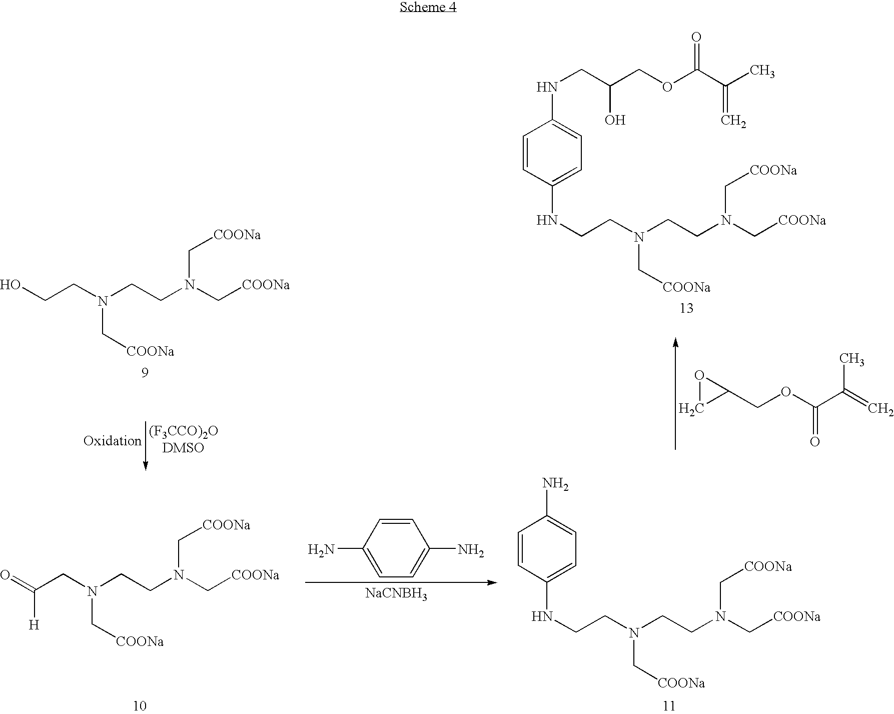

An exemplary route to N-methacryloyl-N′-(N″,N″-bis-carboxymethyl)aminoethyl-p-phenylenediamine is set forth in Scheme 5. N-(2-hydroxyethyl)iminodiacetic acid 14 is oxidized to aldehyde 15. The aldehyde is reductively aminated and amine 16 is acylated with a polymerizable moiety precursor, affording 17.

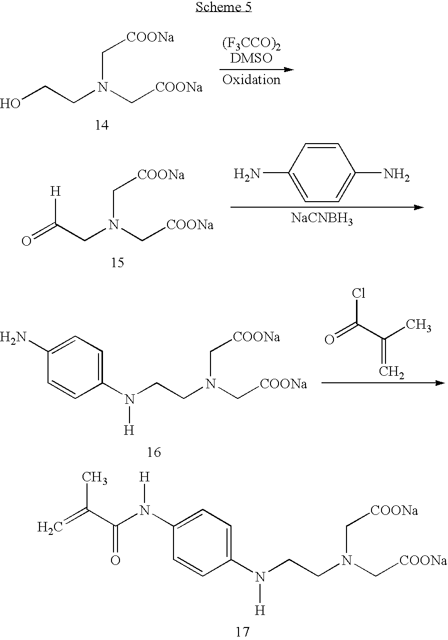

Scheme 6 provides an exemplary scheme for preparing N-(2-hydroxy-3-methacryloyloxy)propyl-N′-(N″,N″-bis-carboxymethyl)aminoethyl-p-phenylenediamine. N-(2-hydroxyethyl)iminodiacetic acid 14 is oxidized to aldehyde 15. The aldehyde is reductively aminated, providing amine 16, which is acylated with a polymerizable moiety precursor to form 18.

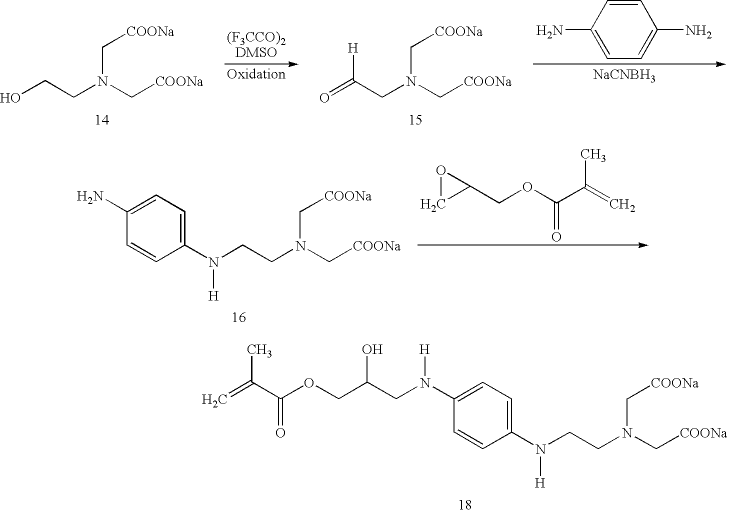

The schemes set forth above are exemplary and illustrate selected methods of preparing compounds of the invention. The schemes are not limiting and those of skill will understand that numerous other schemes and variations on the schemes presented herein are of use to prepare compounds of the invention.

D. Chelating Polymers

The polymers of this invention comprise chelating moieties of this invention. Two methods, in particular, are contemplated for creating these polymers. In one method, chelating monomers comprising polymerizable moieties are polymerized to form a polymer. In another method, an existing polymer, such as a polysaccharide, e.g., dextran, is derivatized with the chelating moieties of this invention. In either case, the polymer can be used as a linear polymer, or can be cross-linked, thereby allowing formation of a hydrogel.

This invention includes chelating polymers that are homo-polymers, co-polymers and blended polymers (that is, a polymer having a first structure or functionality (e.g., linker or chelating moiety of a first structure) mixed with a polymer having a second structure or functionality (e.g., linker or chelating moiety of a second structure different from linker or chelating moiety of first structure).

Moreover, the polymer can include energy absorbing moieties that facilitate desorption and ionization of analytes in contact with the polymer, for example in laser desorption/ionization mass spectrometry. The hydrophilicity of the polymer can be tuned by including selected amounts of a hydrophilic subunit in the polymer. Moreover, the polymer can be made UV curable, e.g., cross-linkable, by including a UV curable subunit within the polymer.

In the sections that follow each subunit of the polymer is discussed in greater detail and is exemplified. Selected embodiments of the polymer are exemplified and discussed. Moreover, methods of making devices that include a polymer of the invention, as well as methods of using the polymers and devices to detect an analyte are also set forth.

In an exemplary embodiment, the polymer is a cross-linked polymer. The cross-linked polymer is essentially water-insoluble. In a further exemplary embodiment, the cross-linked polymer is a hydrogel.

i. Polymers Formed by Polymerizing Chelating Monomers

In an exemplary method of preparing the polymers of the invention, one or more of the monomers above are assembled into a chelating polymer of this invention. The monomers are combined in selected proportions and subjected to polymerization reaction conditions so that bulk polymer has a pre-selected proportion of the various subunits described above. The polymer prepared according to this method can be prepared in bulk, and later distributed onto a device of the invention. Alternatively, for example when the polymer is used in conjunction with a biochip, the monomers can be deposited on a pre-selected region of the chip and polymerized in situ.

In this embodiment the polymer of the invention includes a plurality of monomeric chelating subunits that include a chelating moiety that complexes a metal ion. The metal ion captures one or more analyte, in a sample, to which the immobilized metal ion binds. The chelating moieties are analogous to those moieties typically used in chromatography to capture classes of molecules with which they interact and can be selected to have a desired charge at a particular pH value. One of the advantages of the polymers of the invention and surfaces that include these polymers is their utility to chelate a variety of metal ions. Polymers with this property provide access to a wide range of strategies to experimentally control analyte, e.g., protein adsorption to the polymer.

In an exemplary embodiment the polymer is formed by polymerizing an acrylic or an alkylacrylic, e.g., methylacrylic, monomer. An exemplary methylacrylic monomer of use in forming the polymer of the invention has the formula:
PM-L-Ar-L¹-CM
wherein PM is a polymerizable moiety comprising at least one bond which is a member selected from H₂C═CH₂ and H₂C═C(CH₃). The meaning of the other symbols is as discussed above.

Exemplary species for the linker, L, include carbon, substituted or unsubstituted alkyl and substituted or unsubstituted heteroalkyl moieites, including, but not limited to species having the formulae:

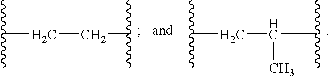

In an exemplary embodiment, L includes or is the group CH₂CH(OH)CH₂OC(O). In a preferred embodiment L includes or is CH₂CH(OH)CH₂OC(O), and the polymerizable group is (CH₃)C═CH₂. Further exemplary L groups include (CH₂)₁₋₁₀, (CH₂CH₂O)₁₋₁₀₀₀.

Those of skill will appreciate that the formulae above are equally relevant to polymerizable monomers that are based upon an acrylic, rather than a methacrylic framework.

In another embodiment, the chelating polymer is polyurethane based. For example, the chelating monomer can include a hydroxyl moiety. This monomer is polymerized with monomers having at least two isocyanate units into a polyurethane that includes pendant chelating groups. (See, e.g., U.S. patent application Ser. No. 10/965,092, filed Oct. 14, 2004 (Chang et al.), incorporated herein by reference. The resulting polymer is readily functionalized with an array of different functional groups and binding functionalities to provide a chelating polymer having a selected property, e.g., affinity for a particular analyte or class of analytes.

One can cross-link linear polymers formed by the polymerization of polymeric monomers by including in the polymerization a cross-linking monomer, e.g., a monomer that comprises two polymerizable moieities. For example, in forming acrylamide or methacrylamide based polymers, one can add bis-acrylamide or bis-methacrylamide.

Exemplary polymers of the invention include the subunit: 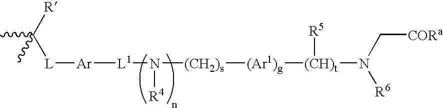
in which R′ is selected from H and substituted or unsubstituted alkyl. The identity of the other radicals is discussed above.

In a preferred embodiment, the subunit according to the formula above has the structure:

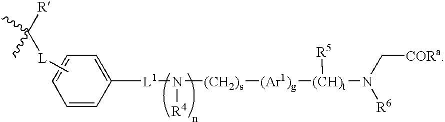

ii. Chelating Polymers Formed by Derivatizing Existing Polymers with Chelating Moieties

In another embodiment, the chelating polymers of this invention are formed by decorating existing polymers with chelating moieties. In this case, one employs a molecule comprising a chelating moiety and a reactive moiety. The reactive moiety chosen depends on the particular chemical reaction by which the molecule is to be coupled to the polymer.

In one embodiment, the polymer is a polysaccharide, such as dextran. Methods of making dextran decorated with various binding moieties is described in, for example, U.S. Patent Publication 2003/0218130 A1 (Boschetti et al., “Biochips with surfaces coated with polysaccharide-based hydrogels,” Nov. 27, 2003). The process involves modifying dextran to comprise polymerizable moieties, such as a vinyl groups, and coupling the modified dextran to monomers comprising a polymerizable moiety and a binding moiety (in the present case, a chelating moiety). For example, the polysaccharide, e.g. dextran, is reacted with a bifunctional molecule comprising a polymerizable moiety and a reactive moiety that couples to the polysaccharide. For example, dextran can be reacted under alkaline conditions with glycidyl methacrylate, epoxymethylacrylamide, e.g. N-methyl-N-glycidyl-methacrylamide, glycidyl acrylate, acryloyl-chloride, methacryloyl-chloride or allyl-glycidyl-ether. These molecules are bifunctional molecules comprising a polymerizable methacrylate molecule or methacrylamide molecule at one end and a reactive epoxide group at the other end. The epoxide reacts with hydroxyl moieties in the dextran in a covalent coupling reaction. The result is “modified dextran” comprising dangling methacrylate or methacrylamide groups. A solution is mixed comprising the modified polysaccharide, a polymerizable monomer comprising a chelating moiety and a polymerization initiator. The polymerization reaction may be initiated using any known copolymerization initiator. Preferred co-polymerization reactions are initiated with a light sensitive catalyst, a temperature sensitive catalyst or a peroxide in the presence of an amine.

Such a polymer can also be formed as a cross-linked polymer by any of a number of methods. In one method, the polymerization mixture just described is also provided with cross-linking monomers, such as bis-acrylamide or bis-methacrylamide.

In another embodiment, a cross-linked polymer is formed by blending first linear polysaccharide-based polymer molecules described above with second polysaccharide molecules derivatized with photopolymerizable, or UV curable, moieties such as benzophenone. For example, 4-benzoylbenzoic acid is reacted with dextran by using 1,3-dicyclohexylcarbodiimide as a coupling reagent to prepare benzophenone-modified dextran. Upon exposure to light, the photoreactive groups react with abstractable hydrogen atoms on both the first and second polymer molecules to form reacted photo-crosslinking groups that bridge the polymers. Such polysaccharide-based cross-linked polymers are preferably prepared as hydrogels. This method is described in more detail in U.S. Patent Publication 2005/0059086 A1 (Huang et al., “Photocrosslinked hydrogel blend surface coatings,” Mar. 17, 2005).

For example, a large number of photo-polymerizable moieties are known in the art. The discussion that follows exemplifies this component of polymers of the invention by reference to the benzophenone group, however, those of skill understand that it is equally relevant to other UV curable groups, e.g., a diazoester, an arylazide and a diazirine.

In an exemplary embodiment, the chelating polymer of the invention includes a photopolymerizable moiety having the general formula: 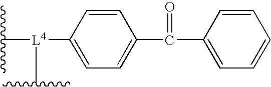
in which L⁴ is a linker that is a bond, substituted or unsubstituted alkyl and substituted or unsubstituted heteroalkyl. The linker includes a bond to another subunit of the polymer, such as a non-chelating subunit that includes a hydrophilic moiety, a non-chelating subunit that includes an energy absorbing moiety and a chelating subunit that is a member of the plurality of chelating subunits in the polymer.

In a further exemplary embodiment, the linker, L⁴, includes the structure: 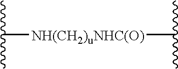
in which u is an integer from 1 to 10.

An exemplary photopolymerizable monomer that is of use to incorporate a UV curable subunit into the polymers of the invention has the formula: 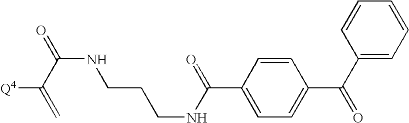
in which Q⁴ is H or substituted or unsubstituted C₁-C₆ alkyl, e.g., methyl.

The photopolymerizable moiety can be introduced into the polymer through use of a photopolymerizable moiety with a polymerizable moiety (PM) attached thereto. Alternatively, the photopolymerizable moiety is introduced by reacting a photopolymerizable moiety with a reactive functional group with a reactive functional group of complementary reactivity on a preformed polymer.

As will be readily understood by those of skill in the art, though the polymers of the invention are exemplified hereinabove by reference to polymers that are formed from methacrylamide monomers, the structures set forth above also describe embodiments in which one or more of the monomers is an acrylamide monomer of an alkyl acrylamide monomer (e.g., substituted with substituted or unsubstituted C₁-C₆ alkyl other than methyl).

iii. Hydrophilic Monomeric Subunits

In certain embodiments, the polymer of this invention is a co-polymer comprising chelating monomeric subunits, hydrophilic monomeric subunits and, optionally, cross-linking monomeric subunits. In cross-linked form, such polymers function as hydrogels. This includes both the polymers based on acrylamide polymerization and polysaccharide-based polymers. In these cases, the polymer comprises hydrophilic subunits that function to enhance the interaction of water with the polymer, particularly the water of an aqueous sample mixture applied to the polymer. An exemplary hydrophilic subunit includes a primary or secondary alcohol, polyol, thiol, polythiol or combinations thereof. Preferably the subunit has two, three or four groups selected from hydroxyls and thiols. Exemplary hydrophilic subunits include alkyl triols, e.g., propyl triols, butyl triols, pentyl triols and hexyl triols. A specific example is trimethylol propane. The hydrophilic subunit is incorporated into the polymer by co-polymerizing a polymerizable monomer that includes the chelating moiety and a polymerizable monomer that includes the hydrophilic moiety. Exemplary polymerizable groups on the hydrophilic polymerizable monomer include, but are not limited to, acrylic, methylacrylic and vinyl moieties.

When the polymer includes only the chelating subunit and a hydrophilic subunit, certain structures for the hydrophilic subunit can be excluded. For example, in these embodiments, it is generally preferred that the hydrophilic subunit is a species formed by the polymerization of a group other than acrylamide and simple unsubstituted alkyl derivatives thereof, e.g., acrylamide, methacrylamide, N-methylacrylamide, N,N-dimethyl(meth)acrylamide, N-isopropy(meth)acrylamide, N-(2-hydroxypropyl)methacrylamide, N-methylolacrylamide. Other groups that generally are excluded from the genus “hydrophilic subunit,” when the polymer includes only a chelating and a hydrophilic subunit, include N-vinylformamide, N-vinylacetamide, N-vinyl-N-methylacetamide, poly(ethylene glycol)(meth)acrylate, poly(ethylene glycol)monomethyl ether mono(meth)acrylate, N-vinyl-2-pyrrolidone, glycerol mono((meth)acrylate), 2-hydroxyethyl(meth)acrylate, vinyl methylsulfone and vinyl acetate. Any of the above-enumerated excluded subunits can be utilized when the polymer includes a third subunit, e.g., EAM subunit, UV curable subunit, in addition to the chelating and hydrophilic subunit. Moreover, any of the excluded subunits are optionally used when the polymer is incorporated into a device, such as a biochip, or when the polymer is used to practice a method of the invention.

An exemplary hydrophilic subunit of use in the polymers of the invention has the formula: 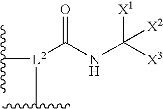
in which X¹, X² and X³ represent groups that are independently selected from H, OH, substituted or unsubstituted alkyl, or substituted or unsubstituted heteroalkyl unsubstituted alkyl. In an exemplary embodiment, one of X¹, X² or X³ is alkyl substituted with one or more OR⁷, in which R⁷ is H, or C¹—C⁴ alkyl. L² is a linker that joins the hydrophilic subunit to another subunit of the polymer. In selected hydrophilic subunits of use in polymers the invention, at least two of X¹, X² and X³ are independently selected from OH, heteroalkyl and alkyl substituted with one or more OR⁷. In an exemplary embodiment, each of X¹, X² and X³ is CH₂OH.

A further exemplary hydrophilic subunit includes a moiety that is a diol, or an ether, for example, an alkylene glycol, a poly(alkylene glycol), or an alkyl, aryl, heteroaryl or heterocycloalkyl diol. When the hydrophilic moiety is a poly(alkylene glycol), such as polyethylene glycol or polypropylene glycol, it preferably has a molecular weight from about 200 to about 20,000, more preferably from about 200 to about 4000.

In an exemplary embodiment, the hydrophilic subunit is selected so that the polymer containing this subunit is more hydrophilic than an identical polymer without the hydrophilic subunit.

The hydrophilic moiety can be introduced into the polymer through use of a hydrophilic moiety with a polymerizable moiety (PM) attached thereto. Alternatively, the hydrophilic moiety is introduced by reacting a hydrophilic moiety with a reactive functional group of complementary reactivity on a preformed polymer.

Exemplary polymerizable hydrophilic monomers of use in preparing the polymers of the invention have the formula: 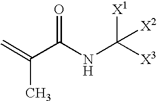
in which the X¹, X² and X³ represent the groups discussed above, and Q¹ is H, or substituted or unsubstituted C₁-C₆ alkyl, e.g., methyl.

An exemplary hydrophilic polymerizable monomer of use in the invention has the formula: 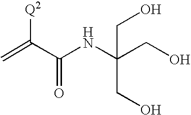
Q² is H, or substituted or unsubstituted C₁-C₆ alkyl, e.g., methyl.

iv. EAM Subunit

Exemplary chelating polymers of the invention can be functionalized with one or more energy absorbing subunit that includes a component conveniently designated as an energy absorbing molecule (EAM) moiety. Generally, these functionalities are incorporated into the chelating polymer through a polymerizable monomer that includes the desired EAM moiety and a polymerizable moiety, e.g., acrylate, methacrylate, vinyl, etc.

EAM subunits in the chelating polymer are useful for promoting desorption and ionization of analyte into the gas phase during laser desorption/ionization processes. The EAM subunit comprises a photo-reactive moiety. The photo-reactive moiety includes a group that absorbs photo-radiation from a source, e.g., a laser, converts it to thermal energy and transfers the thermal energy to the analyte, promoting its desorption and ionization from the chelating polymer.

In the case of UV laser desorption, exemplary EAM subunits include an aryl nucleus that absorbs photo-irradiation, e.g., UV or IR. Exemplary UV photo-reactive moieties include benzoic acid (e.g., 2,5 di-hydroxybenzoic acid), cinnamic acid (e.g., α-cyano-4-hydroxycinnamic acid), acetophenone, quinone, vanillic acid (isovanillin), caffeic acid, nicotinic acid, sinapinic acid, pyridine, ferrulic acid, 3-amino-quinoline and derivatives thereof. An IR photo-reacitve moiety can be selected from benzoic acid (e.g., 2,5 di-hydroxybenzoic acid, 2-aminobenzoic acid), cinnamic acid (e.g., α-cyano-4-hydroxycinnamic acid), acetophenone (e.g. 2,4,6-trihyroxyacetophenone and 2,6-dihyroxyacetophenone), trans-3-indoleacrylic acid, caffeic acid, ferrulic acid, sinapinic acid, 3-amino-quinoline, picolinic acid, nicotinic acid, acetamide, salicylamide and derivatives thereof. In the case of IR laser desorption, exemplary EAM subunits include an aryl nucleus or a group that absorbs the IR radiation through direct vibrational resonance or in slight off-resonance fashion. Representative polymerizable EAM monomers of use in preparing the polymers of the invention are described in Kitagawa et al., published U.S. Patent Application 2003/0207462.

E. Devices/Articles of Manufacture

The devices (articles of manufacture) of this invention comprise a solid support or substrate having a surface and a chelating moiety of the invention or a polymer of the invention attached to the surface through physi- or chemi-sorption. Solid supports include, for example, chromatographic supports (e.g., particles, fibers and monoliths), probes (including probes used, for example, in mass spectrometry or real time analysis such as surface plasmon resonance), microtiter plates and membranes. (These formats are not mutually exclusive.)

The following section details six exemplary methods for making a device of this invention in which a chelating polymer is attached to a solid substrate.

In a first embodiment, a chelating polymer or blended chelating polymer is applied to the substrate surface and becomes attached non-covalently.

In a second embodiment, chelating monomers are polymerized or co-polymerized with other monomers upon the surface of the substrate, and attached non-covalently. For example, a chelating monomer comprising an acrylate or methacrylate group is polymerized with or without a cross-linking moiety on the surface of a substrate. The resulting polymer may be physisorbed to the surface or chemisorbed, depending on the nature of the surface.

In a third embodiment, chelating monomers are polymerized or co-polymerized with other monomers on a surface comprising moieties to which the polymer can be attached covalently. For example, a chelating monomer comprising an acrylate or methacrylate group is polymerized with or without a cross-linking moiety on the surface of a substrate that, itself, comprises polymerizable moieties, such as vinyl or acrylate groups. In another embodiment, the polymer is a co-polymer of chelating monomers and benzophenone monomers, and the surface comprises groups with which the benzophenone can couple upon curing. The monomers are both polymerized and cured on the surface.

In a fourth embodiment, a chelating polymer, co-polymer or blended polymer is covalently attached to a surface through a reactive moiety. For example, a chelating polymer is applied to a surface that already has a polymer with benzophenone groups on it. Upon curing, a blended polymer results, whereby the chelating polymer is attached to the polymer already on the surface.

In a fifth embodiment, a chelating moiety can be covalently incorporated into polymer backbone by modifying a pre-formed polymer already attached to a substrate.

In a sixth embodiment, a chelating moiety can be covalently attached to the solid support, for example, by using reactive groups on the moiety and the support.

i. Chromatographic Materials

In an exemplary embodiment, the chelating material of the invention is combined with a chromatographic support to form a chromatographic material. Supports used in chromatography include, for example, particles, fibers and monoliths. Typically, the chromatographic material is disposed in a container such as a column or flow plate, and sample comprising the analyte to be isolated is passed through the material.

1. Particles

Particulate substrates that are useful in practicing the present invention can be made of practically any physicochemically stable material used in chromatography. This includes, for example, porous mineral materials, such as hydroxyapatite-zirconia, and organic material, such as cellulose beads. Useful particulate substrates are not limited to a size or range of sizes. The choice of an appropriate particle size for a given application will be apparent to those of skill in the art. The solid support may be in the form of beads or irregular particles. In a preferred embodiment, the solid support is of a size range from about 5 microns to about 1000 mm in diameter.

2. Monoliths

A monolith is a single piece of material, generally porous, to which chromatographic ligands can be attached. Generally monoliths have significantly greater volume than beads, for example, in excess of 0.5 mL per cm³ of monolith.

ii. Probes

Probes are substrates on which an analysis of some kind is carried out. Typically, a probe is insertable into an analytic device that performs a measurement. In certain embodiments, the probes of this invention are chips or plates insertable into a scanner that interrogates the chip surface to detect binding events on the surface. Such detection methods are described in more detail below. Thus, the chelating moieties of this invention are attached to a chip surface either directly or as part of a polymer. Those of skill will appreciate that chip formats other than a biochip are usefully practiced with the chelating polymers of the invention. In another embodiment, the probe is a mass spectrometry probe, e.g., a probe comprising means for engaging a probe interface of a mass spectrometer.

Substrates that are useful in practicing the present invention can be made of any stable material, or combination of materials. Moreover, the substrates can be configured to have any convenient geometry or combination of structural features. The substrates can be either rigid or flexible and can be either optically transparent or optically opaque. The substrates can also be electrical insulators, conductors or semiconductors. When the sample to be applied to the chip is water based, the substrate preferably is water insoluble.

The surface of a substrate of use in practicing the present invention can be smooth, rough and/or patterned. The surface can be engineered by the use of mechanical and/or chemical techniques. For example, the surface can be roughened or patterned by rubbing, etching, grooving, stretching, and the oblique deposition of metal films. The substrate can be patterned using techniques such as photolithography (Kleinfield et al., J. Neurosci. 8: 4098-120 (1998)), photoetching, chemical etching and microcontact printing (Kumar et al, Langmuir 10: 1498-511 (1994)). Other techniques for forming patterns on a substrate will be readily apparent to those of skill in the art.

The size and complexity of the pattern on the substrate is controlled by the resolution of the technique utilized and the purpose for which the pattern is intended. For example, using microcontact printing, features as small as 200 nm have been layered onto a substrate. See, Xia et al., J. Am. Chem. Soc. 117: 3274-75 (1995). Similarly, using photolithography, patterns with features as small as 1 μm have been produced. See, Hickman et al., J. Vac. Sci. Technol. 12: 607-16 (1994). Patterns that are useful in the present invention include those which comprise features such as wells, enclosures, partitions, recesses, inlets, outlets, channels, troughs, diffraction gratings and the like.

In an exemplary embodiment, the patterning is used to produce a substrate having a plurality of adjacent addressable features, wherein each of the features is separately identifiable by a detection means. In another exemplary embodiment, an addressable feature does not fluidically communicate with other adjacent features. Thus, an analyte, or other substance, placed in a particular feature remains essentially confined to that feature. In another preferred embodiment, the patterning allows the creation of channels through the device whereby fluids can enter and/or exit the device.

Using recognized techniques, substrates with patterns having regions of different chemical characteristics can be produced. Thus, for example, an array of adjacent, isolated features is created by varying the hydrophobicity/hydrophilicity, charge or other chemical characteristic of a pattern constituent. For example, hydrophilic compounds can be confined to individual hydrophilic features by patterning “walls” between the adjacent features using hydrophobic materials. Similarly, positively or negatively charged compounds can be confined to features having “walls” made of compounds with charges similar to those of the confined compounds. Similar substrate configurations are also accessible through microprinting a layer with the desired characteristics directly onto the substrate. See, Mrkish, et al., Ann. Rev. Biophys. Biomol. Struct. 25:55-78 (1996).

The specificity and multiplexing capacity of the chips of the invention is improved by incorporating spatial encoding (e.g., addressable locations, spotted microarrays) into the chip substrate. Spatial encoding can be introduced into each of the chips of the invention. In an exemplary embodiment, binding functionalities for different analytes can be arrayed across the chip surface, allowing specific data codes (e.g., target-binding functionality specificity) to be reused in each location. In this case, the array location is an additional encoding parameter, allowing the detection of a virtually unlimited number of different analytes.

In the embodiments of the invention in which spatial encoding is utilized, they preferably utilize a spatially encoded array comprising m regions of chelating polymer distributed over m regions of the substrate. Each of the m regions can be a different chelating polymer or the same chelating polymer, or different chelating polymers can be arranged in patterns on the surface. For example, in the case of matrix array of addressable locations, all the locations in a single row or column can have the same chelating polymer. The m binding functionalities are preferably patterned on the substrate in a manner that allows the identity of each of the m locations to be ascertained. In another embodiment, the m chelating polymers are ordered in a p by q matrix (p×q) of discrete locations, wherein each of the (p×q) locations has bound thereto at least one of the m chelating polymer. The microarray can be patterned from essentially any type of chelating polymer of the invention.

1. Mass Spectrometer Probe

In an exemplary embodiment, the chip of this invention is designed in the form of a probe for a gas phase ion spectrometer, such as a mass spectrometer probe. To facilitate its being positioned in a sample chamber of a mass spectrometer, the substrate of the chip is generally configured to include means that engage a complementary structure within the probe interface. The term “positioned” is generally understood to mean that the chip can be moved into a position within the sample chamber in which it resides in appropriate alignment with the energy source for the duration of a particular desorption/ionization cycle. There are many commercially available laser desorption/ionization mass spectrometers. Vendors include Ciphergen Biosystems, Inc., Waters, Micromass, MDS, Shimadzu, Applied Biosystems and Bruker Biosciences.

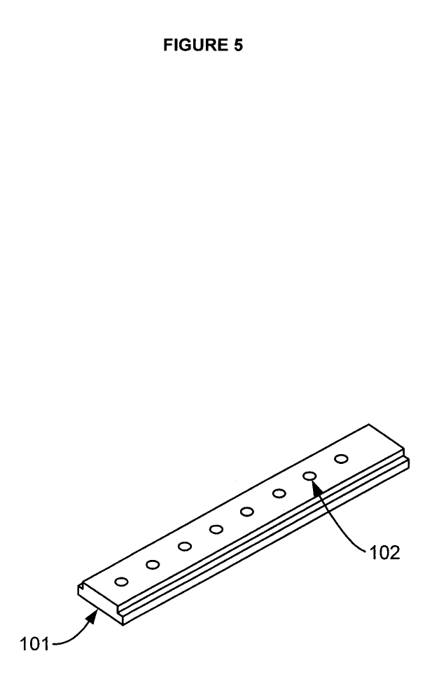

An exemplary structure according to this description is a chip that includes means for slidably engaging a groove in an interface, such as that used in the Ciphergen probes (FIG. 5). In this figure, the means to position the probe in the sample chamber is integral to substrate 101, which includes a lip 102 that engages a complementary receiving structure in the probe.

In another example, the probe is round and is typically attached to a holder/actuator using a magnetic coupler. The target is then pushed into a repeller and makes intimate contact to insure positional and electrical certainty.

Other probes are rectangular and they either marry directly to a carrier using a magnetic coupling or physically attach to a secondary carrier using pins or latches. The secondary carrier then magnetically couples to a sample actuator. This approach is generally used by systems which have autoloader capability and the actuator is generally a classical x, y 2-d stage.

In yet another exemplary embodiment, the probe is a barrel. The barrel supports a polymer, hydrogel or other species that binds to an analyte. By rotating and moving in the vertical plane, a 2-d stage is created.

Still a further exemplary embodiment the probe is a disk. The disk is rotated and moved in either a vertical or horizontal position to create an r-theta stage. Such disks are typically engaged using either magnetic or compression couplers.

In one aspect, the invention provides a device in chip format removably inserted into the probe region of a mass spectrometer.

In an exemplary embodiment, the probe includes an aluminum support that is coated with a layer of silicon dioxide. The silicon dioxide layer is optionally from about 1000-3000 Å in thickness, and can be functionalized with a linker arm of one or more structure; a typical linker arm includes a polymerizable moiety that reacts with a complementary moiety on the polymer. In other embodiments, the substrate is formed from or includes a polymeric material, such as cellulose or a plastic. In another embodiment, the chip is comprised of a polymeric material doped with a conductive material.

In an embodiment preferred for SELDI, the probe has the form of a chip with a substantially flat surface. A polymeric material of this invention is attached to the surface of the chip. The polymer preferably is a cross-linked polymer forming a hydrogel. The polymer can be physisorbed of chemisorbed to the surface. The polymer can coat the entire chip, but preferably is attached at a plurality of discrete, addressable locations on the chip, typically in a pattern such as a line or array.

In a preferred embodiment, the probe is an aluminum base array where discrete spots are individualized over the flat surface. The modified surface of the spot (after introduction of acrylic double bonds by chemical vapor deposition of an acrylic silane) is loaded with O-methacryloyl-N,N-bis-carboxymethyl-tyrosine monomer and then copomymerized by means of UV in the presence of appropriate initiators. Onto this chip is polymerized the polymer of Example 7. In this case, the cross-linked polymer is covalently attached to the chip surface.

iii. Micro-, Nano-titer Plates

In another exemplary embodiment, the polymer of the invention is used in a device that is in a multi-welled device format, e.g., micro- or nano-titer plate. For example, a layer of the polymer can be used to coat the interior of the wells of the multi-welled substrate. Alternatively, the inner surface of the wells of the nano- or micro-titer plates is formed from the polymer itself. Popular formats for micro- and nano-titer plates include 48-, 96- and 384-well configurations. In an exemplary embodiment, the plate is made of a polymer, e.g., polypropylene.

iv. Membranes

In an exemplary embodiment, the polymer of the invention is used to form a membrane. For example, a layer of the polymer is used to coat a porous substrate. Alternatively, the membrane is formed from the polymer itself. The membranes of the invention are optionally formed by methods known in the art. See, for example, Mizutani, Y. et al., J. Appl. Polym. Sci. 1990, 39, 1087-1100), Breitbach, L. et al, Angew. Makromol. Chem. 1991, 184, 183-196 and Bryjak, M. et al., Angew. Makromol. Chem. 1992, 200, 93-108).

F. Methods of Using Articles of Manufacture

The metal chelators of this invention are useful for capturing metal ions from a solution. Metal chelates (metal chelators to which metals are bound) are useful for binding molecules such as biological molecules that bind metals. These include, in particular, polypeptides and, more particularly, polypeptides that comprise histidine and/or tyrosine residues. In particular, polymers and devices of the invention are useful in performing assays of substantially any format including, but not limited to chromatographic capture, immunoassays, competitive assays, DNA or RNA binding assays, fluorescence in situ hybridization (FISH), protein and nucleic acid profiling assays, sandwich assays, laser desorption mass spectrometry and the like.

The methods of the invention can be practiced with articles prepared by any of the exemplary routes summarized in Section E, above.

i. Methods of Removing Metal Ions from Solution

The metal chelators of this invention are useful in removing metal ions from solution. Thus, for example, they are useful in purifying aqueous solutions, such as water. In such methods the aqueous solution is contacted with chromatographic materials of this invention that comprise chelating moieties. Metal ions bind the metal chelators. Then the more purified aqueous solution is collected from the chromatographic material. In one embodiment, this invention contemplates chromatography filters, for example in cartridge form, for water purification. Another embodiment involves contacting linear polymers of this invention with a solution comprising metal ions, allowing the chelating moieties to bind the metals, and then removing the polymer from the solution by filtration or centrifugation. The chelating moieties of the invention are designed to chelate essentially any metal ion including, but not limited to, those of the transition, lanthamide and actinide series.

ii. Methods of Purifying Analytes

The metal chelate moieties of the articles of this invention are useful for purifying analytes, e.g., proteins, from mixtures. In an exemplary embodiment, the metal chelates are utilized in immobilized metal ion affinity chromatographic (IMAC) purification modalities.

IMAC is an especially sensitive separation technique and also applicable to most types of proteins. More specifically, IMAC utilizes matrices that include a group capable of forming a chelate with a metal ion, e.g., transition metal ion. The chelate is used as the ligand in IMAC to bind to and immobilize a compound from solution. The binding strength in IMAC is affected predominately by the species of metal ion, the pH of the buffers and the nature of the ligand used. For example, it is often observed that nickel chelates preferentially bind polypeptides having histidine residues, in particular recombinant proteins comprising histidine tags. By contrast, copper is a less specific binder of proteins and captures a wider range of proteins than nickel does. Since the metal ions are strongly bound to the matrix, the adsorbed protein can be eluted either by lowering the pH or by competitive elution.

In general, IMAC is useful for separation of proteins or other molecules that present an affinity for the transition metal ion of the matrix. For example, proteins having accessible histidine, cysteine and tryptophan residues, which all exhibit an affinity for the chelated metal, will bind to the matrix through one interaction of one or more of these residues with the metal ion.

With the advent of molecular biological techniques, proteins are now easily tailored or tagged with one or more histidine (or other metal binding amino acid) residues in order to increase their affinity to chelated metal ions. Accordingly, IMAC has assumed a more important role in the purification of proteins.

As set forth above, one can chelate the chelating moieties of the articles of the present invention with a variety of metals. Transition metal ions are generally preferred, however, neither the articles nor their use is limited to chelates of transition metals, lanthamides and actinides. Examples of ions useful in practicing the present invention include copper, iron, nickel, colbalt, gallium, magnesium, manganese and zinc. Articles of this invention, loaded with metal ions, preferentially capture certain types of biological molecules from a mixture. Unbound material from the mixture can be removed and the bound material can be isolated from the metal chelate by, for example, elution, in more purified form.

iii. Methods of Detecting Analytes

The probes and plates of this invention are useful for the detection of analyte molecules. The metal chelates of the materials of the invention, act as a capture reagent; the polymer will capture analytes that interact with the metal chelate. Unbound materials can be washed off, and the analyte can be detected in any number of ways including, for example, a gas phase ion spectrometry method, an optical method, an electrochemical method, atomic force microscopy and a radio frequency method. Gas phase ion spectrometry methods are described herein. Of particular interest is the use of mass spectrometry and, in particular, SELDI. Optical methods include, for example, detection of fluorescence, luminescence, chemiluminescence, absorbance, reflectance, transmittance, birefringence or refractive index (e.g., surface plasmon resonance, ellipsometry, quartz crystal microbalance, a resonant mirror method, a grating coupler waveguide method (e.g., wavelength-interrogated optical sensor (“WIOS”) or interferometry). Optical methods include microscopy (both confocal and non-confocal), imaging methods and non-imaging methods. Electrochemical methods include voltametry and amperometry methods. Radio frequency methods include multipolar resonance spectroscopy or interferometry. Optical methods include microscopy (both confocal and non-confocal), imaging methods and non-imaging methods.

1. SELDI-MS

In one method, analytes are detected by SELDI. In this method, a SELDI probe comprising a metal chelator of this invention is charged with a metal ion of choice, typically by adding a solution comprising the metal to a hydrogel comprising the chelating moiety. Then, a solution comprising the protein analyte of interest is applied to the chip and incubated to allow binding of proteins. Unbound proteins are then washed off the chip. Typically an energy absorbing molecule, for example sinnipinic acid or another MALDI matrix material, is added to the chip. Then, the chip is inserted into the probe interface of a laser desorption mass spectrometer. The laser desorbs and ionizes polypeptides bound to the chip and they are detected mass spectrometry.

The methods of the present invention are useful to detect any target, or class of targets, which interact with a binding functionality in a detectable manner. Exemplary target molecules include biomolecules such as a polypeptide (e.g., peptide or protein), a polynucleotide (e.g., oligonucleotide or nucleic acid), a carbohydrate (e.g., simple or complex carbohydrate) or a lipid (e.g., fatty acid or polyglycerides, phospholipids, etc.). The target can be derived from any sort of biological source, including body fluids such as blood, serum, saliva, urine, seminal fluid, seminal plasma, lymph, and the like. It also includes extracts from biological samples, such as cell lysates, cell culture media, or the like.

The following examples are provided to illustrate selected embodiments of the invention and are not to be construed as limiting its scope.

### IV. Examples

### Example 1

### Synthesis of trisodium Salt of N-(p-vinylphenyl)methyl-ethylenediaminetriacetic acid

As shown in Scheme 1, St-P-HEDA possesses a styrene type C═C polymerizable group, a hydrophobic benzene ring and an ethylenediaminetriacetic acid chelating moiety with 5 binding sites (three —COOH groups and two nitrogen atoms). This monomer was prepared through a three-step process.

In the first step, vinylbenzoldehyde (5.0 g) reacted with an excess amount of ethylenediamine (12-fold) to form a reductive amination product. This reaction was performed in the presence of sodium cyanoborohydride (1.6 g) and titanium isopropoxide, a catalyst. This reductive amination product incubated for about 16 h at room temperature. After the incubation period, methanol (150 mL) and water (8 mL) were added to the product to form a precipitate. The precipitate was subsequently removed by filtration. The liquid portion was concentrated by evaporation. The product was precipitated in ether, washed with ether and dried at about 35° C. under a vacuum overnight.

In the second step, ethyl bromoacetate (15.5 g) was reacted in methanol with sodium carbonate, a catalyst. The reaction lasted 44 h under refluxing. The solid was removed by filtration and the liquid portion was concentrated by evaporation.

In the third step, hydrolysis was carried out to release the carboxyl groups. The intermediate product of the second step was mixed with an aqueous solution of sodium hydroxide (4.4 g in 100 mL water) and heated up to about 60° C. for 44 h. The product was precipitated in acetone, washed with acetone and dried at about 35° C. under a vacuum overnight.

### Example 2

### Synthesis of trisodium Salt of O-methacryloyl-N,N-bis-carboxymethyl tyrosine

As shown in Scheme 2, TM possesses a methacrylate type polymerizable group, a hydrophobic benzene ring and an nitrilo-triacetic acid type chelating moiety with four binding sites (three —COOH groups and one nitrogen atom). This monomer was prepared through a three-step process.

In the first step, tyrosine methyl ester (TME) reacted with ethyl bromoacetate (3 moles amount compared to 1 mole of TME) in methanol and in the presence of sodium carbonate, a catalyst. After reacting for 48 h at about 60° C., the solid was removed by filtration and the methanol was evaporated off. The remaining intermediate was used in the second step of the reaction.

The second step of the reaction was hydrolysis in which both the carboxyl groups and the hydroxyl group were released. The intermediate of the first step reacted with 5 equivalents of sodium hydroxide in water at about 60° C. for 48 h. The resulting sodium salt was precipitated in acetone, washed with acetone, and consequently, used in the third step.

In the third step, the released phenyl group reacted with methacryloyl chloride to attach the polymerizable methacryloyl group. This reaction was performed at 0° C. using an excess amount of methacryloyl chloride (4 eq.). After 3 hours elapsed, sodium hydroxide was added to regulate the pH to about 6.0. The product was precipitated into acetone, washed with acetone, and dried at about 35° C. under a vacuum overnight.

### Example 3

### Synthesis of trisodium Salt of N-{[4-(methacryloylamino)phenyl]-amino}ethyl-N,N′N′-ethylenediaminetriacetic acid

As shown in Scheme 3, MA-P-HEDA possesses a methacrylamide type polymerizable group, a hydrophobic benzene ring and an ethylenediaminetriacetic acid chelating moiety with 5 binding sites (three —COOH groups and two nitrogen atoms). This monomer was prepared through a three-step process.

In the first step, the hydroxyl group of N-2-hydroxyethyl-ethylenediaminetriacetic acid (HEDA) oxidized into an aldehyde group. This oxidation reaction was performed by reacting HEDA (6.0 g) with trifluoroacetic anhydride (5.0 g) in DMSO at room temperature for 3 days.

In the second step, the reductive amination product of the formed aldehyde group from the first step reacted with an excess amount (10 eq.) of p-phenylenediamine (23.3 g). This reaction was successively carried out in the presence of sodium cyanoborohydride (1.0 g) at room temperature for 48 h. The resulting amino-HEDA was precipitated in acetone, washed with acetone, and used in the third step of the process.

In the third step, the amino group of amino-HEDA reacted with methacryloyl chloride to attach the polymerizable methacryloyl group. This reaction was performed at 0° C. using an excess amount of methacryloyl chloride (3 eq.). After 3 h, sodium hydroxide was added to regulate the pH to about 6.0. The product was precipitated into acetone, washed with acetone, and dried at about 35° C. under a vacuum overnight. The powder was further washed with ethyl acetate for several times, and dried under vacuum.

### Example 4

### Synthesis of trisodium Salt of N-{[4-(2-hydroxy-3-methacryloyloxypropylamino)phenyl]-amino}ethyl-N,N′N′-ethylenediaminetriacetic acid

As shown in Scheme 4, GMA-P-HEDA possesses a methacrylate type polymerizable group, a hydrophobic benzene ring and an ethylenediaminetriacetic acid chelating moiety with 5 binding sites (three —COOH groups and two nitrogen atoms). This monomer was prepared also through a three-step process.

The first and second steps were carried out in the same manner used for the preparation of MA-P-HEDA (Example 3, Scheme 3).

In the third step, the amino-HEDA and an excess amount of glycidyl methacrylate (5-fold), instead of methacryloyl chloride described in Example 3, reacted with each other at 45° C. for 8 h. The resulting product was precipitated in acetone, washed with acetone, and dried at about 35° C. under a vacuum overnight.

### Example 5

### Synthesis of disodium Salt of N-methacryloyl-N′-(N″,N″-bis-carboxymethyl)aminoethyl-p-phenylenediamine

As shown in Scheme 5, MA-P-IDA possesses a methacrylamide type polymerizable group, a hydrophobic benzene ring and an IDA type chelating moiety with 3 binding sites (two —COOH groups and one nitrogen atom). This monomer was prepared through a three-step process.

This reaction was performed in the same manner as used for the preparation of MA-P-HEDA (Example 3, Scheme 3) except the starting reagent HEDA was replaced with N-(2-hydroxyethyl)iminodiacetic acid (HIDA) as control. The control chip is commercially available from Ciphergen Biosystems, Inc.

### Example 6

### Synthesis of disodium Salt of N-(2-hydroxy-3-methacryloyloxy)propyl-N′-(N″,N″-bis-carboxymethyl)aminoethyl-p-phenylenediamine

As shown in Scheme 6, GMA-P-IDA possesses a methacrylate type polymerizable group, a hydrophobic benzene ring and an IDA type chelating moiety with 3 binding sites (two —COOH groups and one nitrogen atom). This monomer was prepared through a three-step process.

This reaction was performed in the same manner as used for the preparation of GMA-P-HEDA (Example 4, Scheme 4) except the starting reagent HEDA was replaced with N-(2-hydroxyethyl)iminodiacetic acid (HIDA).

### Example 7

### Preparation of Arrays Comprising a chelating polymer (IMAC 50 array)

Chelating monomer TM (Scheme 2, 0.20 g), N-[tris(hydroxymethyl))methyl acrylamide (0.60 g), N,N′-methylenebis(acrylamide) (0.04 g) were dissolved in a mixture of DI water (3.4 g) and glycerol (3.4 g). This solution (0.70 g) was diluted 5-fold using a mixture of water and ethanol (1/2.7 by weight). Then, 65 μL of DMSO solution (5% by weight) of 2-hydroxy-(4-hydroxyethoxyphenyl)-2-methyl propanone was added. The above solution was deposited onto a silanated substrate (Example 8, 1.5 μL/spot) and the photo-polymerization was carried out with a near UV exposure system for 10 min. Then, the resulting arrays were washed with NaCl aqueous solution, followed by ID water washing twice and dried at 60° C. for 30 min.

### Example 8

### Preparation of ProteinChip Array with Spots Coated with O-Methacryloyl-N,N-bis-carboxymethyl tyrosine chelating co-polymer

A SiO₂-coated aluminum substrate was chemically cleaned with 0.01N HCl and methanol in an ultrasonic bath for 20 min. After wet cleaning, the aluminum substrates were further cleaned with a UV/ozone cleaner for 30 min. For CVD silanation, the SiO₂-coated aluminum substrates were placed in a reaction chamber along with 3-(trimethoxysilyl)propyl methacrylate (Aldrich). The chamber was evacuated under vacuum, the silane was vaporized and reacted with the surface. The reaction was carried out at 170° C. for 30 min.

The formation of methacrylate-coated silane layer on the surface was confirmed with surface reflectance FTIR and contact angle measurements.

### Example 9

### Detection of a peptide, ITIH4 Internal Fragment, on Ciphergen IMAC 50 Array

A peptide, ITIH4 internal fragment, having a predicted mass of 3275.70 D, was captured and detected on a Ciphergen IMAC 50 array. The IMAC 50 array is described in Example 8. The protocol follows.

1.0 Buffers

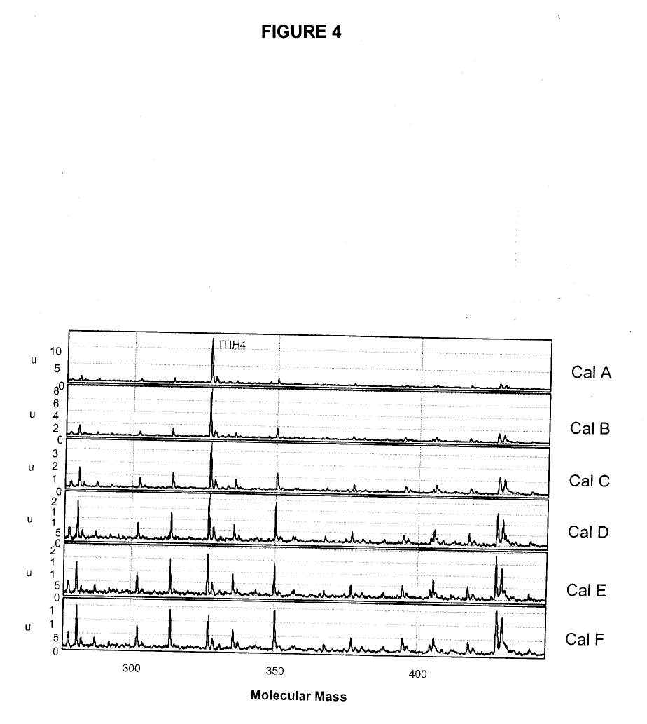

1.1 Sample binding/washing buffer: 50 mM sodium phosphate, pH 6.0, 250 mM sodium chloride
1.2 50 mM sodium phosphate, pH 6.0, 250 mM sodium chloride, 100 mM imidazole
1.3 IMAC charging solution: 50 mM CuSO₄, prepare by diluting the stock solution 1:1 with water
   2.0 Preparation of ITIH4 Calibration Standards
2.1 Stock ITIH4 of 1 mg/mL as 10 μL aliquots. Dilute 10 fold with 90 μL of water. Save as 20 μL aliquots in 0.5 mL Eppendorf tubes at −80° C.
2.2 Add 0.1 μg/μL ITIH4 peptide standard (20 μL) to 80 μL Intergen serum in a 0.5 mL Eppendorf tube (total: 20 ng/μL ITIH4 in serum), and mix. Store 30 μL aliquots in −80° C. freezer. Thaw one aliquot for each day of assay.
2.3 Add 30 μL of 20 ng/μL ITIH4 to 30 μL of Intergen serum in tube=10 ng/μL. Mix. Spot A
2.4 Add 30 μL 10 ng/μL ITIH4 to 120 μL Intergen serum in a tube=2 ng/μL. Mix. Spot B
2.5 Add 40 μL 2 ng/μL ITIH4 to 40 μL Intergen serum in a tube=1 ng/μL. Mix. Spot C
2.6 Add 40 μL 1 ng/μL ITIH4 to 40 μL Intergen serum in a tube=0.5 ng/μL. Mix. Spot D
2.7 Add 40 μL 0.5 ng/μL ITIH4 to 40 μL Intergen serum in a tube=0.25 ng/μL. Mix. Spot E
2.8 Add 40 μL 0.5 ng/μL ITIH4 to 40 μL Intergen serum in a tube=0.125 ng/μL. Mix. Spot F
2.9 Take 40 μL Intergen serum=0 ng/μL. Spot G
2.10 Add 20 μL of each standard to 980 μL IMAC binding/washing buffer (50 mM Na phosphate 0.25 M NaCl pH6) in an eppendorf tube=1:50 dilution.
2.11 Add 20 L of 2 ng/μL to 980 μL IMAC binding buffer containing 100 mM Imidazole (50 mM Na phosphate 0.25 M NaCl pH6, 100 mM imidazole) to be loaded on the last two spots as negative control for the chemistry. Spot H
2.12 Standard solutions are ready to be added to IMAC50 Cu Arrays.
   3.0 ITIH4 Assay Protocol on IMAC50
3.1 The following protocol is done on Biomek.
3.2 Load 50 μl CuSO₄ to each well. Spin bioprocessors at 800 rpm for 1 min. Shake for 10 min (20, 5, 10) (form, amplitude, time; “MicroMix 5” from Diagnostics Products Corporation). Remove copper solution.
3.3 Wash with 150 μL water 4 times, shaking for 2 min in between each wash (20, 5, 2).
3.4 Equilibrate with 150 μL IMAC binding/washing buffer (50 mM Na phosphate 0.25 M NaCl, pH 6) two times, shaking for 5 min in between each wash (20, 5, 5).
3.5 Load 50 μL samples/standards to each well. Spin bioprocessors at 800 rpm for 1 min.
3.6 Seal bioprocessors with tape. Incubate on Micromix (15, 3, 60) at room temperature for 1 h. Remove samples.
3.7 Wash with 150 μL IMAC binding/washing buffer 3 times, shaking for 5 min in between each wash (20, 5, 5).
3.8 Wash with 150 μL water 2 times, shaking for 2 min in between each wash (20, 5, 2).
3.9 Remove bioprocessor top, flick chip cassette by hand to remove remaining water.
3.10 Air dry chips for 10 min.
3.11 Add 0.75 μL sinapinic acid solution two times, with drying for 5 min between the two additions of sinapinic acid.
3.12 1 tube of 5 mg sinapinic acid+200 μL acetonitrile+200 μL 1% TFA, mix to dissolve.
3.13 Read on Ciphergen PCS4000, focus at 3272 Da, 2-100 KDa mass range, collect 10 shots at ¼ partitions and a total of 530 shots. The results for spots A-F (2.3-2.8) are displayed in FIG. 4.

All publications and patent documents cited in this application are incorporated by reference in their entirety for all purposes to the same extent as if each individual publication or patent document were so individually denoted. By their citation of various references in this document, Applicants do not admit any particular reference is “prior art” to their invention.

What is claimed is:

1. A compound having the formula:
PM-L-Ar-L¹-CM
wherein
PM is a polymerizable moiety comprising at least one bond which is a member selected from H₂C═CH and H₂C═C(CH₃);
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 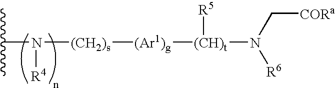
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl.

2. The compound according to claim 1, PM comprising a moiety having a structure which is a member selected from CH₂═CH and CH₂═C(CH₃).

3. The compound according to claim 1 wherein
L comprises CH₂CH(OH)CH₂OC(O); and
said polymerizable group is (CH₃)C═CH₂.

4. The compound according to claim 1 wherein Ar is substituted or unsubstituted phenyl.

5. A polymer comprising pendant chelating moieties wherein the chelating moieties have the formula: 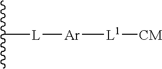
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 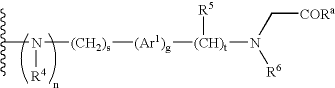
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl.

6. The polymer according to claim 5 wherein L comprises CH₂CH(OH)CH₂O.

7. The polymer according to claim 5, having the formula: 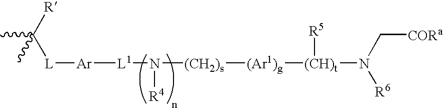
wherein
R′ is a member selected from H and substituted or unsubstituted alkyl.

8. The polymer according to claim 7, having the formula:

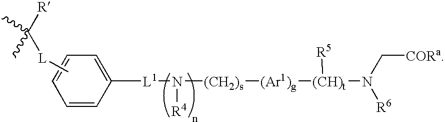

9. The polymer according to claim 8, wherein L is a member selected from O, S and NH.

10. The polymer according to claim 5, wherein said polymer comprises a plurality of monomeric subunits comprising a moiety of a different structure than said chelating moiety having the structure:

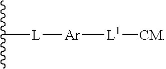

11. The polymer according to claim 5, further comprising a metal ion chelated by at least one of said metal chelating subunits.

12. The polymer according to claim 11 wherein said metal ion is a member selected from an ion of copper, iron, nickel, colbalt, gallium and zinc.

13. The polymer according to claim 11, further comprising an analyte bound to said polymer through an interaction with said metal ion.

14. The polymer according to claim 13 wherein said analyte is a member selected from an oligonucleotide and a peptide.

15. A polymer according to claim 5 wherein polymeric chains can be cross-linked so that to form an insoluble hydrogel under different shapes such as beads, membranes, rods, discs and irregular pieces.

16. A device comprising a solid support comprising a polymer chemisorbed or physisorbed to said solid support, said polymer comprising linked monomeric subunits wherein a plurality of said monomeric subunits are chelating subunits having the formula: 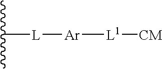
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 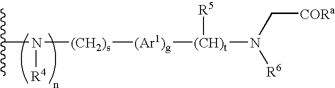
wherein
n, s and t are integers independently selected from 0 and 1, and at least one of sand t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl.

17. The device according to claim 16, further comprising an analyte adsorbed onto said polymer.

18. The device according to claim 17, further comprising a laser desorption/ionization matrix contacting said analyte.

19. The device according to claim 17 wherein said analyte is adsorbed onto said molecular host through an interaction between said analyte and a metal ion bound by said chelating moiety of said polymer.

20. The device according to claim 16 wherein said substrate comprises means for engaging a probe interface of a mass spectrometer.

21. The device according to claim 16 wherein said polymer is distributed on said substrate in a plurality of addressable locations.

22. The device according to claim 16 wherein said solid support is selected from a bead, a chip, a membrane, a monolith and combinations thereof.

23. The device according to claim 16, wherein said polymer comprises a plurality of monomeric subunits having a structure different than said monomeric subunit having the structure:

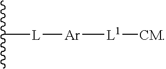

24. A method of detecting an analyte comprising:
(a) binding said analyte to a metal ion chelated by a polymer bound to a substrate, said polymer comprising linked monomeric subunits wherein a plurality of said monomeric subunits are chelating subunits having the formula: 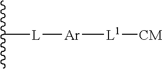
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 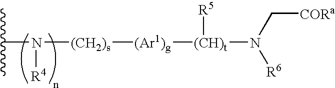
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl; and
(b) detecting the bound analyte.

25. The method according to claim 24 wherein said substrate is a component of a probe for mass spectrometry; and said detecting is by matrix-assisted laser desorption ionization mass spectrometry.

26. The method of claim 24 comprising detecting said analyte by laser desorption/ionization mass spectrometry.

27. The method of claim 24, further comprising:
(c) contacting said analyte with a laser desorption/ionization matrix that absorbs energy from a photo-irradiation source and transfers said energy to an analyte with which it is in operative contact, thereby promoting desorption and ionization of said analyte.

28. The method of claim 24, further comprising:
(d) irradiating a member selected from said analyte, said matrix and a combination thereof with a laser, thereby desorbing said analyte from said polymer.

29. The method according to claim 24, wherein said polymer comprises a plurality of monomeric subunits having a different structure than said monomeric subunit having the structure:

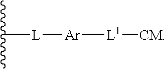

30. A method of separating an analyte from a contaminant, said method comprising:
(a) binding said analyte to a metal ion chelated by a chelating subunit of a polymer, said polymer comprising a plurality of linked monomeric subunits, a plurality of which are said chelating subunit, said chelating subunit having the formula: 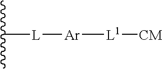
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³), —NH, O-(L³), and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 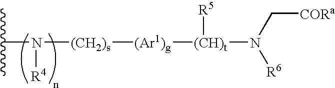
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl; and
(b) removing said contaminant from the bound analyte.

31. The method according to claim 30, further comprising:
(c) following step (b), removing said analyte from said metal ion chelated by a chelating subunit of said polymer.

32. The method according to claim 31 wherein said removing comprises a step selected from desorbing said analyte from said metal ion and eluting said analyte from said metal ion.

33. A method of making a chelating polymer comprising linked monomeric subunits wherein a plurality of said monomeric subunits are chelating subunits having the formula: 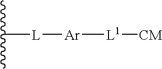
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 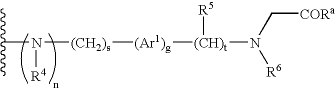
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl;
said method comprising:
(a) polymerizing a monomer having the formula:
PM-L-Ar-L¹-CM
wherein
PM is a polymerizable moiety comprising at least one bond which is a member selected from H₂C═CH and H₂C═C(CH₃).

34. A mass spectrometer comprising an ion source comprising a probe interface that positions a probe in an interrogatable relationship with a laser source, and a probe engaged with said interface, said probe comprising:
a substrate having a surface comprising a polymer chemisorbed or physisorbed to said surface, said polymer comprising linked monomeric subunits wherein a plurality of said monomeric subunits are chelating subunits having the formula: 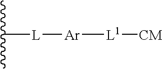
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 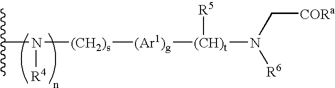
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl.

35. A method of removing a metal ion from a solution, said method comprising:
(a) binding said metal ion with a chelating subunit of a polymer forming a polymer-metal ion complex, said polymer comprising a plurality of linked monomeric subunits, a plurality of which are said chelating subunit, said chelating subunit having the formula: 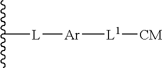
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 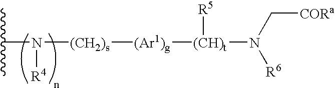
wherein
n, s and t are integers independently selected from 0 and 1, and at least one of s and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl; and
(b) separating the polymer-metal ion complex from said solution, thereby removing said metal ion from said solution.

36. A device comprising a solid support functionalized with a plurality of chelating subunits having the formula: 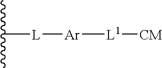
wherein
L is a linker which is a member selected from zero-order linkers, and higher order linkers which are members selected from C(O)-(L³)ᵤ, C(O)O-(L³)ᵤ, OC(O)-(L³)ᵤ, C(O)NH-(L³)ᵤ, (L³)ᵤ-C(O)NH, NH-(L³)ᵤ, (L³)ᵤ-NH, O-(L³)ᵤ and (L³)ᵤO
wherein
L³ is substituted or unsubstituted alkyl and substituted or unsubstituted heteroalkyl; and
u is 0 or 1;
Ar is a member selected from aryl and heteroaryl;
L¹ is a linker which is a member selected from (CR¹R²)ₘ, O(CR¹R²)ₘ, (CR¹R²)ₘO S(CR¹R²)ₘ, (CR¹R²)ₘS and (R³)N(CR¹R²)ₘ
wherein
R¹, R² and R³ are members independently selected from H and substituted or unsubstituted alkyl; and
m is an integer from 0 to 10;
CM is a chelating moiety having the formula: 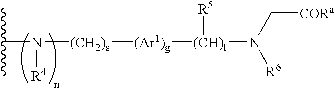
wherein
n, s and t are integers independently selected from 0 and 1, and at least one of and t is 1;
g is an integer from 0 to 3;
Ar¹ is selected from substituted or unsubstituted aryl and substituted or unsubstituted heteroaryl;
R^{a} is selected from OR^{b} and O⁻M⁺
wherein
M⁺ is a metal ion; and
R^{b} is a member selected from H, substituted or unsubstituted alkyl and substituted or unsubstituted heteroalkyl; and
R⁴, R⁵ and R⁶ are members independently selected from H and (CH₂)_{q}COR^{c}, and at least one of R⁴, R⁵ and R⁶ is other than H
wherein
q is an integer from 0 to 3; and
R^{c} is a member selected from NHR^{d}, OR^{d}, O⁻M⁺, substituted or unsubstituted alkyl and substituted or unsubstituted heteroalkyl
wherein
M⁺ is a metal ion; and
R^{d} is a member selected from H, substituted or unsubstituted alkyl and substituted or unsubstituted heteroalkyl.

37. The device according to claim 36 wherein said solid support is in a format selected from a plate, a chip, a membrane, a particle, a monolith and combinations thereof.
